(19) United States
(12) Patent Application Publication
(10) Pub. No.: US 2026/0051269 A1
(43) Pub. Date: Feb. 19, 2026

(54) Container Labeling and Method of Use

(71) Applicant: Global Conservation LLC, Canyon Country, CA (US)

(72) Inventor: Karan SANEINIA, Thousand Oaks, CA (US)

(73) Assignee: Global Conservation LLC, Canyon Country, CA (US)

(21) Appl. No.: 19/301,098

(22) Filed: Aug. 15, 2025

Related U.S. Application Data
(60) Provisional application No. 63/683,381, filed on Aug. 15, 2024.

(51) Int. Cl. G09F 3/00; B65C 3/14; B65C 9/40; B65C 9/46; G09F 3/02

(52) U.S. Cl. CPC G09F 3/0297; B65C 3/14; B65C 9/40; B65C 9/46; G09F 2003/0208; G09F 2003/0272

(57) ABSTRACT

The present disclosure provides a container labeling system comprising a labeling unit equipped with one or more applicators for applying one or more elements onto a container label. The elements are selected from numbers, letters, characters, diagrams, pictures, pictograms, symbols, colors, shades, hues, marks, sounds, displays, icons, graphics, objects, lines, curves, text, dots, shapes, data, photographs, and images. The system includes a control unit configured to differentially configure the elements on each container label based on predetermined criteria. The labeling unit applies the elements using techniques such as printing, thermal printing, embossing, debossing, or engraving. The system enables the production of unique, identifiable labels for containers, enhancing product tracking, authentication, and user experience.

### CROSS-REFERENCE TO RELATED APPLICATIONS

This application claimed benefit of and priority to U.S. Provisional Patent Application No. 63/683,381, entitled, “Container Labeling and Method of Use,” by Karan Saneinia, filed Aug. 15, 2024, which is hereby incorporated by reference in its entirety.

### FIELD OF THE DISCLOSURE

The present invention relates to container labeling systems, and more specifically, to a device, apparatus, and method for uniquely identifying drink containers and other types of containers using distinctive labels and identifiers.

### BACKGROUND OF THE INVENTION

Container identification and labeling systems have long been utilized across various industries to distinguish between similar-looking products and prevent confusion among users. In social settings, commercial establishments, and industrial applications, the ability to quickly and accurately identify individual containers becomes particularly challenging when multiple similar containers are present in the same environment. Traditional labeling approaches often rely on standard text-based information such as brand names, product descriptions, and regulatory information, which may not provide sufficient visual distinction for rapid identification purposes.

The proliferation of similar-looking beverage containers and other consumer products has created situations where individuals struggle to distinguish their personal items from those of others. This challenge becomes more pronounced in group settings such as parties, workplace environments, educational institutions, and recreational facilities where multiple people may have containers with identical or nearly identical appearances. The lack of distinctive visual markers can lead to confusion, potential hygiene concerns, and waste when individuals discard containers due to uncertainty about ownership or contents.

Current labeling technologies face limitations in providing adequate customization and personalization options for end users. While manufacturers typically focus on brand recognition and regulatory compliance in their labeling strategies, there remains a gap in addressing individual identification needs. Existing solutions often require additional accessories, complex application processes, or fail to integrate seamlessly with standard container designs, limiting their practical adoption and effectiveness.

Previous labeling and marking systems include the following:

U.S. Pat. No. 6,745,505 to Breidenbach et al. discloses a color coded beverage cap collection with permanent passive indicia indicating beverage bottle user identities. The system provides beverage bottles with respective color-coded beverage caps having permanent passive non-verbal indicia indicating the identity of the user without tangible surface-interfering customized or temporary identifiers. The color-coded bottle caps serve as actual caps for conventional beverage bottles and do not add cumulative indicia to existing bottle caps beyond the variety of distinct colors.

U.S. Pat. No. 10,832,015 to various inventors describes on-the-fly marking systems for consumer packaged goods. The system comprises a package handling device, a clock, and a printer system for printing on each package of a web of successive packages a permanent record indicative of product attributes. The system includes database driven manufacturing processes that allow customized products to be tailored to specific demographics and retail locations through variable imaging and routing capabilities.

U.S. Pat. No. 6,086,702 to Rea presents a method for personalizing beverage containers utilizing field labels which are removably mounted on containers. The method involves removing portions of labels from containers, organizing them in desired sequences, and remounting them at new locations on containers to spell names or other identifying information.

Chinese Utility Model No. 201834419 to various inventors discloses a beverage bottle system where different individual beverage bottles within a single unit have different markings on bottle caps and bottle bodies. The system addresses difficulty in distinguishing between individual bottles of the same beverage type by providing different markings such as numbers, letters, or patterns on caps and bodies to avoid waste and prevent disease transmission.

U.S. Patent Publication No. 2009/0266735 to Moore describes a personalizable beverage bottle name label providing an empty marked area on existing beverage labels where consumers can write personal names, initials, or identification. The personalizable area is incorporated into label layout and design before printing and can be added to any area of existing labels containing beverage identification information.

These prior art solutions, while addressing aspects of container identification, fail to provide a comprehensive, versatile, and easily implementable system that can be applied across various container types and social settings. There remains a need for an improved labeling system that combines case of use, adaptability, and effective visual identification to enhance the drink consumption experience in social gatherings and commercial settings.

### BRIEF SUMMARY OF THE PRESENT INVENTION

The present invention provides a label for a drink container or any other kind of container, comprising one or more elements selected from the group consisting of numbers, letters, characters, diagrams, pictures, pictograms, symbols, colors, shades, hues, marks, sounds, displays, icons, graphics, objects, lines, curves, text, dots, shapes, data, photographs, images, and/or other content; said label being adhered to a bottle, can, or other container.

One element of the device includes the one or more elements being configured to convey information related to the contents, branding, or usage instructions of said drink container. The one or more elements may comprise a QR code or barcode for enabling digital interaction or product verification. The one or more elements may further comprise luminescent materials that emit light in response to external stimuli. The one or more elements may be arranged in a pattern or design that is unique to the specific drink container, providing a distinctive visual appearance. The one or more elements may comprise a thermochromic material that changes color in response to temperature variations. The one or more elements may comprise a set of tactile markings or textures to enhance the sensory experience of the user.

In one aspect of the present invention, the invention provides a method for manufacturing the label, comprising the steps of: Designing the label with the desired one or more elements; Selecting appropriate materials for printing or embedding the one or more elements; Applying the label to a bottle, can, or other container using adhesive or other attachment methods. The method may further comprise quality control steps to ensure accurate representation and application of the one or more elements on the label and container.

In another aspect, the invention provides a method for manufacturing container labels during the manufacturing stage, comprising: Providing a plurality of containers; Applying one or more elements selected from the group consisting of numbers, letters, characters, diagrams, pictures, pictograms, symbols, colors, shades, hues, marks, sounds, displays, icons, graphics, objects, lines, curves, text, dots, shapes, data, photographs, images, and/or other content onto each container label; Said one or more elements on each container label being differentially configured. The one or more elements may be applied onto each container label using printing, thermal printing, embossing, debossing, or engraving techniques. The one or more elements on each container label may convey information related to the contents, origin, quality, or manufacturing process of the container. The one or more elements on each container label may be differentially configured based on the type, size, shape, or material of the container. The one or more elements on each container label may be differentially configured to enable product differentiation, tracking, or anti-counterfeiting measures. The one or more elements on each container label may comprise variable data, allowing each container label to be unique within a manufacturing batch. The one or more elements on each container label may comprise visually distinct patterns, enabling easy identification and differentiation of containers. The one or more elements on each container label may comprise machine-readable codes, including QR codes, barcodes, or RFID tags, for automated sorting, tracking, and inventory management. The one or more elements on each container label may comprise a combination of visual and auditory elements, providing a multi-sensory identification system.

In another aspect, the invention provides a system for manufacturing container labels, comprising: A labeling unit equipped with one or more applicators for applying one or more elements selected from the group consisting of numbers, letters, characters, diagrams, pictures, pictograms, symbols, colors, shades, hues, marks, sounds, displays, icons, graphics, objects, lines, curves, text, dots, shapes, data, photographs, images, and/or other content onto each container label; A control unit configured to differentially configure said one or more elements on each container label based on predetermined criteria.

### BRIEF DESCRIPTION OF THE DRAWINGS

Non-limiting and non-exhaustive examples are described with reference to the following figures.

Although various colors are described throughout this specification as identification elements, it should be understood that the figures are presented in black and white, with different colors represented by different patterns, shadings, or visual textures for illustration purposes.

FIG. 1 illustrates a container labeling system for adding unique marks to containers, in accordance with one embodiment of the present invention.

FIG. 2 illustrates a container with a cap and a label featuring a three-section layout, in accordance with one embodiment of the present invention.

FIG. 3 illustrates the label with the three-section layout where an identifier section contains a letter, in accordance with one embodiment of the present invention.

FIG. 4 illustrates the label with the three-section layout featuring the identifier section containing an object, in accordance with another embodiment of the present invention.

FIG. 5 illustrates the label incorporating the three-section layout with the identifier section containing an image of an animal, in accordance with another embodiment of the present invention.

FIG. 6 illustrates the label incorporating the three-section layout with the identifier section containing an emoji symbol, in accordance with another embodiment of the present invention.

FIG. 7 illustrates the label including a QR code and barcode for digital interaction capabilities, in accordance with one embodiment of the present invention.

FIG. 8 illustrates multiple containers for identification and differentiation in group settings, in accordance with one embodiment of the present invention.

FIG. 9 illustrates a method for manufacturing labels, in accordance with one embodiment of the present invention.

FIG. 10 illustrates a method for determining label attachment methods, in accordance with one embodiment of the present invention.

FIG. 11 illustrates a method for multi-sensory identification, in accordance with one embodiment of the present invention.

FIG. 12 illustrates a method of implementing a dynamic assignment algorithm for outputting final unique identification signatures, in accordance with one embodiment of the present invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this Specification are hereby incorporated by reference in their entireties. References cited in an Information Disclosure Statement should not be construed as an admission that the cited reference comes from an area that is analogous or directly applicable to the invention, but rather that the reference is being cited out of an abundance of caution.

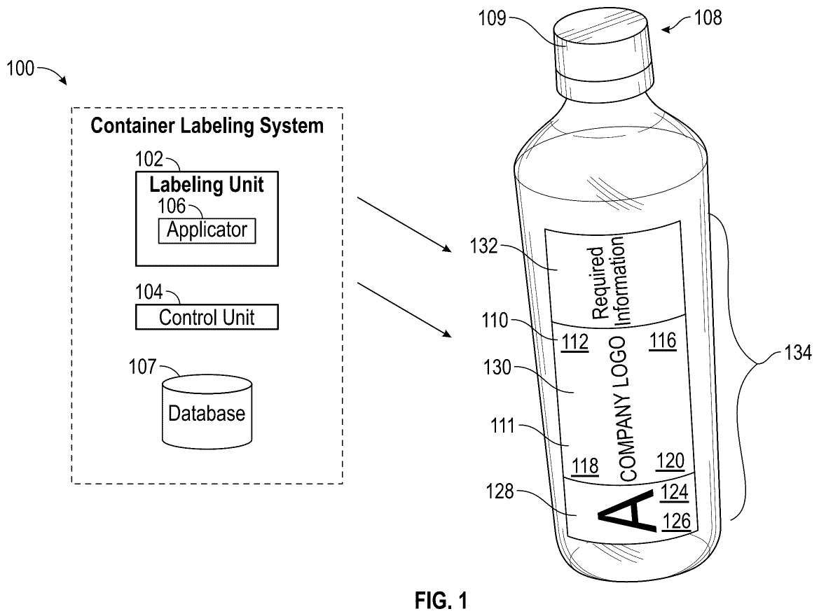

FIG. 1 shows a representative diagram of a container labeling system 100, in accordance with one embodiment of the present invention. Container labeling system 100 includes components that work together to produce and put labels with special identifiers. Container labeling system 100 includes a labeling unit 102 and a control unit 104. In the present embodiment, labeling unit 102 works as the main tool within container labeling system 100, while control unit 104 runs the settings and timing of the labeling process. Labeling unit 102 includes an applicator 106 to physically stick or apply labels on containers 108. Labeling unit 102 applies distinctive identifiers to containers 108 to facilitate differentiation between morphologically similar containers 108. Labeling unit 102 incorporates multiple application mechanisms that accommodate diverse substrate materials and affixation methodologies. Applicator 106 utilizes adhesive bonding, thermal fusion, or mechanical fastening systems to secure labels to container surfaces. Labeling unit 102 interfaces with containers 108 of variable dimensions, geometries, and compositions through implementation of adjustable positioning apparatus and configurable application parameters.

Control unit 104 executes algorithmic assignment and application of labels 110 with differentiated attributes through computational processes that ensure each container 108 receives a unique identification signature. In some implementations, container labeling system 100 incorporates a database 107 for maintaining comprehensive repositories of label design specifications and unique identification signature assignments. Control unit 104 interfaces with database 107 to access archived label design templates, monitor previously allocated identification signatures, and generate novel combinations that maintain uniqueness across production batches. The linking process may involve associating unique container identifiers with user accounts through digital registration systems, connecting identification signatures to consumer profiles that track purchase history and product preferences, integrating with product authentication databases that verify container authenticity and supply chain provenance, and establishing connections to tracking systems that monitor container lifecycle from manufacturing through disposal. Control unit 104 executes parametric analysis algorithms that evaluate multiple variables including container morphology, production chronology, and user requirements when determining optimal label design specifications. Control unit 104 synchronizes with labeling unit 102 to ensure precise temporal coordination and spatial positioning of labels 110 during the application sequence.

Database 107 may store comprehensive information about label designs, identification patterns, and assignment histories that support the uniqueness verification process. Database 107 may maintain records of previously used identifier combinations to prevent duplication within production batches or across different manufacturing runs. In some cases, database 107 includes templates for different label configurations that can be modified based on specific container requirements or customer preferences. Database 107 may also store quality control parameters and application specifications that guide labeling unit 102 during the label application process.

Container labeling system 100 may be configured for pre-sale or post-sale application scenarios through adaptable operational modes that accommodate different implementation requirements. In some cases, container labeling system 100 operates during manufacturing processes to apply labels 110 before containers 108 reach retail distribution. Container labeling system 100 may also support post-sale applications where labels 110 are applied by end users after container purchase. Container labeling system 100 ensures each container 108 in a batch has a unique identifier through the coordinated operation of control unit 104, database 107, and labeling unit 102 working together to prevent identifier duplication and maintain distinction between containers.

In the present embodiment, container 108 provides the base structure for receiving identification labels 110. Container 108 may be formed from various materials including glass, plastic, metal, or composite materials that accommodate different beverage types and storage requirements. As used herein, the term “container” may refer to any receptacle, vessel, or enclosure designed to hold, store, or transport liquids, solids, or other substances. Examples of containers 108 may include bottles, cans, jars, cups, boxes, pouches, tubes, vials, and other packaging formats used in beverage, food, pharmaceutical, cosmetic, or industrial applications. Container 108 includes structural features that support label attachment through surface characteristics that enable adhesive bonding, mechanical attachment, or other affixation methods. Container 108 may have cylindrical, square, or curved geometries that accommodate different product categories and manufacturing specifications. Container 108 may be manufactured in different sizes depending on the specific application needs and volume requirements. As known, container 108 may include a cap 109. Cap 109 attaches to container 108 to provide closure and containment functionality for the contents within container 108. Cap 109 may be formed from materials including plastic, metal, or composite materials that provide scaling properties and structural integrity during handling and storage. Cap 109 connects to container 108 through threading, snap-fit mechanisms, or other attachment methods that create secure closure while allowing user access to container contents. In some cases, cap 109 may include surface areas that accommodate label application or identification markings that work with the overall identification system.

Label 110 provides the identification component that enables visual or tactile distinction between otherwise similar-looking containers 108. Label 110 may be configured for application pre-sale during manufacturing processes or post-sale by end users depending on the implementation requirements and user preferences. Label 110 may be configured for use with beverage containers, consumable goods containers, or non-consumable containers through adaptable design specifications that accommodate different container types and applications. Label 110 may be manufactured in different shapes and sizes depending on the specific application requirements and container characteristics. In some cases, label 110 may be configured as a small circular label for bottle caps, a rectangular wraparound label for cylindrical containers, or a custom die-cut shape that matches unique container geometries. Label 110 may be sized to accommodate various container dimensions, ranging from small vials requiring compact identification elements to large industrial containers that provide extensive surface area for comprehensive labeling information. The shape and size of label 110 may be determined based on factors including available surface area on container 108, visibility requirements for identification elements, regulatory compliance needs for informational content, and user interaction preferences for social or commercial applications.

Label 110 may be configured for integration into or affixation onto container 108, cap 109, or closure components through various attachment methods that ensure secure positioning during use. Label 110 includes a substrate 111. Here, substrate 111 forms the base material structure of label 110 and provides the foundation for integrating distinctive identification elements. Substrate 111 may be configured for application to container 108 through adhesive backing, mechanical attachment, or other affixation methods that create secure bonding between label 110 and the surface of container 108. Substrate 111 may be formed from materials including paper, vinyl, polyester, or specialty materials that provide durability and compatibility with different container materials and environmental conditions. Substrate 111 may accommodate printing, embossing, or other application techniques that enable the integration of distinctive elements for container identification purposes.

Label 110 may be configured as adhesive-backed, wrapped, printed, or otherwise affixed to accommodate various container geometries and application scenarios. Label 110 may be configured for one-time use applications where permanent attachment provides long-term identification, or removable reusable scenarios that allow label repositioning or replacement while maintaining brand visibility. Physical relationship between container 108, cap 109, and label 110 creates an integrated identification system where each component contributes to the overall functionality of distinguishing containers 108 in social or commercial environments. Substrate 111 enables the integration of one or more distinctive elements that provide visual or tactile distinction capabilities through material properties and surface characteristics that support various identification technologies and methods.

Distinctive elements may include one or more visual elements 112 and/or one or more tactile elements 116. Referring to FIG. 1, visual element 112 provides distinctive visual identification capabilities within label 110 through various graphical and chromatic features that enable immediate recognition of containers. Visual element 112 may comprise visual identifiers selected from colors, patterns, letters, numbers, symbols, pictures, and logos that create distinctive appearances for individual containers within container labeling system 100. Visual element 112 may be integrated into substrate 111 through printing processes, digital imaging, or other application techniques that create permanent or semi-permanent visual markings on label surfaces. Visual element 112 may include color-coding systems where different hues, shades, or chromatic combinations correspond to specific container categories, user preferences, or identification schemes that facilitate rapid visual distinction in social or commercial environments.

In some cases, visual element 112 may incorporate specialty materials comprising luminescent, thermochromic, or reflective surfaces that provide enhanced visibility characteristics under various environmental conditions. In some cases, visual element 112 includes luminescent materials that emit light in response to external stimuli such as ultraviolet radiation or ambient lighting changes, creating distinctive glowing effects that enhance container identification in low-light conditions. Thermochromic materials within visual element 112 may change color in response to temperature variations, providing dynamic visual feedback that corresponds to container contents temperature or environmental conditions. Visual element 112 may include pictographic elements such as emojis, animal images, symbols, and graphical icons that enable immediate visual recognition without requiring text reading capabilities, supporting identification across different age groups and literacy levels.

Tactile element 116 provides physical identification features within label 110 that enable container distinction through touch-based interaction methods. Tactile element 116 may comprise tactile elements selected from textures, raised surfaces, embossed areas, and engraved areas that create distinctive physical characteristics on label surfaces. Tactile element 116 may be formed through manufacturing processes including embossing, debossing, or engraving techniques that create three-dimensional surface variations within substrate 111. Tactile element 116 may include raised patterns, textural variations, or surface modifications that provide distinctive physical signatures for individual containers, enabling identification through touch in situations where visual identification may be limited by lighting conditions or user capabilities.

Tactile element 116 may incorporate various surface treatments or material applications that create distinctive physical sensations when contacted by users. In some cases, tactile element 116 includes textural patterns that correspond to visual element 112 designs, creating coordinated identification systems that provide both visual and tactile recognition pathways. Tactile element 116 may be positioned within specific areas of label 110 to provide consistent tactile reference points that users can locate through touch-based exploration of container surfaces. Tactile element 116 may include scratch-off areas covered with removable latex-based layers that users can remove to reveal hidden information or designs underneath, creating interactive identification features that engage users while providing distinctive container markings.

Further, label 110 may include one or more elements such as machine-readable codes and interactive digital elements. The interactive digital elements may comprise Near Field Communication (NFC) capabilities that enable wireless data exchange when containers are brought into proximity with compatible devices, augmented reality markers that are scannable using smartphones to access digital content such as three-dimensional (3D) animations, videos, or websites, digital displays including electronic ink (E-ink) screens that can show variable information such as temperature readings or expiration dates, touch-sensitive areas that respond to user contact by activating visual or auditory feedback, and embedded sensors that detect environmental conditions and provide real-time data feedback. The machine-readable codes may include Quick Response (QR) codes 118, barcodes 120, or Radio Frequency Identification (RFID) tags (not shown), for automated sorting, tracking, and inventory management. QR code 118 provides machine-readable identification capabilities within label 110 through digital encoding systems that link containers 108 to electronic information or verification systems. QR code 118 may be integrated into substrate 111 through printing processes that create high-contrast patterns readable by optical scanning devices. QR code 118 may encode various types of information including container identification numbers, product verification data, or links to digital content that enhance user interaction with labeled containers. QR code 118 may enable digital interaction between containers and electronic devices such as smartphones, tablets, or specialized scanning equipment.

QR code 118 may incorporate augmented reality markers that are scannable using smartphones to access digital content such as three-dimensional (3D) animations, videos, or websites that provide enhanced user experiences beyond basic container identification. In some cases, QR code 118 links to digital platforms that provide container tracking, authenticity verification, or interactive content that engages users while supporting the identification functions of container labeling system 100. QR code 118 may be positioned within label 110 to maintain visual balance with visual element 112 and other identification features while ensuring optimal scanning accessibility for users.

Barcode 120 provides linear machine-readable identification capabilities within label 110 through standardized encoding systems that support automated scanning and data retrieval processes. Barcode 120 may comprise machine-readable codes that enable rapid identification and data access through optical scanning devices commonly used in retail, inventory management, or tracking applications. Barcode 120 may be integrated into substrate 111 through printing processes that create precise line patterns with specific width and spacing characteristics that conform to established barcode standards. Barcode 120 may encode container identification information, product codes, or tracking data that supports supply chain management and inventory control processes within container labeling system 100.

Barcode 120 may work in coordination with QR code 118 to provide multiple machine-readable identification options that accommodate different scanning technologies and user preferences. In some cases, barcode 120 includes embedded sound chips programmed to emit specific sounds or melodies when activated by pressing a button, scanning, or opening the container, creating multi-sensory identification experiences that combine visual, tactile, and auditory recognition elements. Barcode 120 may be positioned within label 110 to maintain compatibility with standard scanning equipment while preserving the aesthetic balance of visual element 112 and other identification features. Barcode 120 may include check digits or other verification mechanisms that ensure data accuracy during scanning operations and prevent misidentification due to scanning errors or equipment limitations.

In addition, label 110 may include one or more security features 124. Security features 124 provide authentication and anti-counterfeiting capabilities within label 110 through specialized technologies that prevent unauthorized duplication or tampering with container identification systems. Security features 124 may comprise technologically enhanced features that include holographic elements, microtext, or other specialized markings that are difficult to replicate without specialized equipment or materials. Security features 124 may include tamper-evident properties that provide visible indication of label manipulation or removal attempts. Security features 124 may be integrated into substrate 111 through specialized printing processes, material applications, or manufacturing techniques that create distinctive characteristics verifiable through visual inspection or specialized detection methods.

Security features 124 may incorporate holographic printing techniques that create 3D-like images that appear to change when viewed from different angles, providing dynamic visual effects that are difficult to counterfeit using standard printing equipment. In some cases, security features 124 include microtext or other fine-detail elements that require magnification for verification, creating authentication methods that can be verified by authorized personnel or specialized equipment. Security features 124 may work in coordination with visual element 112, QR code 118, and barcode 120 to create multi-layered authentication systems that provide comprehensive protection against counterfeiting or unauthorized duplication. Security features 124 may include serialization or other tracking elements that enable individual container authentication and supply chain verification through database 107 maintained by control unit 104.

In some cases, label 110 may include reflective surfaces 126 to provide enhanced visibility capabilities within label 110 through materials or coatings that redirect ambient light to improve container identification under various lighting conditions. Reflective surfaces 126 may comprise specialty materials comprising reflective surfaces that enhance visual recognition of containers in low-light environments, outdoor conditions, or situations where ambient lighting may be limited or variable. Reflective surfaces 126 may be integrated into substrate 111 through material selection, coating applications, or specialized printing processes that create light-redirecting properties within specific areas of label 110. Reflective surfaces 126 may work in coordination with visual element 112 to create enhanced visibility effects that improve container identification reliability across different environmental conditions and user scenarios.

Reflective surfaces 126 may include retroreflective materials that direct light back toward the source, creating bright appearance effects when illuminated by flashlights, vehicle headlights, or other directed light sources. In some cases, reflective surfaces 126 incorporate prismatic or holographic properties that create distinctive visual effects while maintaining light-redirecting capabilities that enhance container visibility. Reflective surfaces 126 may be positioned within specific areas of label 110 to create distinctive patterns or designs that combine identification functionality with enhanced visibility characteristics. Reflective surfaces 126 may include weather-resistant properties that maintain reflective performance under exposure to moisture, temperature variations, or other environmental conditions that containers may encounter during storage, transportation, or use within container labeling system 100.

Each label 110 may contain at least one identifier section 128, one branding section 130, one information section 132. Identifier section 128, branding section 130, information section 132 form a three-section layout 134 in label 110. In the present invention, three-section layout 134 provides a structured organizational framework within label 110 that systematically arranges different types of content to optimize both identification functionality and brand visibility.

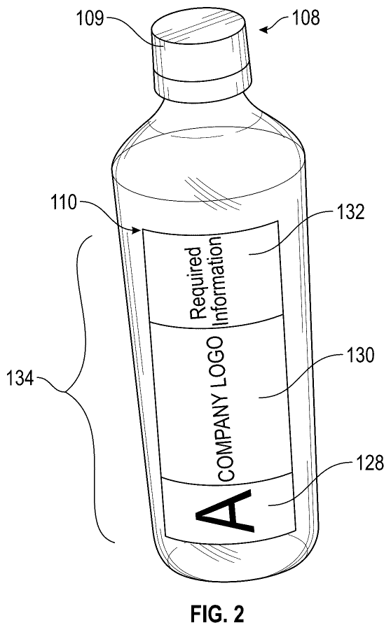

FIG. 2 shows container 108 having label 110 with three-section layout 134, in accordance with one exemplary embodiment of the present invention. Three-section layout 134 divides the surface area of label 110 into distinct zones that accommodate different categories of information while maintaining visual balance and readability across various container sizes and viewing conditions. Three-section layout 134 may be implemented through design templates stored within database 107 that guide control unit 104 in positioning different content elements during label creation processes. Three-section layout 134 may accommodate various label dimensions and aspect ratios while maintaining consistent proportional relationships between sections that support both identification effectiveness and commercial branding requirements.

Three-section layout 134 may be configured for different container geometries and application scenarios through adaptable design parameters that maintain functional organization while accommodating specific implementation requirements. In some cases, three-section layout 134 includes visual separation elements such as lines, borders, or color variations that create clear boundaries between different content areas within label 110. Three-section layout 134 may incorporate proportional sizing algorithms within control unit 104 that automatically adjust section dimensions based on container size, label dimensions, or content requirements while maintaining optimal readability and visual impact. Three-section layout 134 may support both horizontal and vertical orientations depending on container shape and label placement requirements within container labeling system 100.

With continued reference to FIG. 1 and FIG. 2, identifier section 128 forms the primary identification component within three-section layout 134 and contains distinctive pictographic elements that enable rapid visual recognition of individual containers. Identifier section 128 may be positioned within a designated area of label 110 to provide consistent placement of identification elements across different container types and production batches. Identifier section 128 may accommodate various types of visual content including colors, patterns, symbols, and graphical representations that create distinctive visual signatures for individual containers within social or commercial environments. Identifier section 128 may be configured through control unit 104 to receive dynamically assigned identification elements that prevent duplication while maintaining visual distinctiveness across container populations.

Identifier section 128 may contain visual elements selected from emojis, objects, animal images, symbols, and graphical icons that enable immediate visual recognition without requiring text reading capabilities or detailed examination of container surfaces. In some cases, identifier section 128 incorporates high-contrast color schemes and simplified graphical designs that remain visible and recognizable under various lighting conditions including dim ambient lighting, outdoor environments, or crowded social settings. Identifier section 128 may include size specifications that ensure identification elements remain visible and legible across different viewing distances and container handling scenarios. Identifier section 128 may coordinate with database 107 to access libraries of pictographic elements that provide extensive variation options while maintaining consistent visual quality and recognition characteristics.

Branding section 130 occupies the central portion of three-section layout 134 and accommodates company logos, brand names, or other commercial identification elements that maintain brand visibility while supporting container identification functions. Branding section 130 may be configured to display text reading “COMPANY LOGO” or other brand-specific content that preserves commercial value and marketing effectiveness of labeled containers. Branding section 130 may be positioned between identifier section 128 and other content areas to create visual balance while ensuring brand elements remain prominent and recognizable to consumers and users. Branding section 130 may accommodate various logo sizes, text formats, and graphical elements through scalable design parameters that maintain brand integrity across different label dimensions and container applications.

Branding section 130 may incorporate brand-specific color schemes, typography, and design elements that coordinate with existing marketing materials and packaging designs while supporting the identification functions of container labeling system 100. In some cases, branding section 130 includes provisions for variable branding content that allows different brands or product lines to utilize the same three-section layout 134 framework while maintaining distinctive brand presentation. Branding section 130 may be configured through control unit 104 to automatically resize and position brand elements based on available space and label dimensions while preserving brand recognition and visual impact. Branding section 130 may support both text-based and graphical branding elements through flexible content management systems within database 107 that accommodate diverse brand requirements and presentation preferences.

Information section 132 provides designated space within three-section layout 134 for regulatory text, product details, usage instructions, or other informational content that supports consumer safety and regulatory compliance requirements. Information section 132 may contain text reading “Required Information” or other content that fulfills labeling requirements while maintaining the organizational structure of three-section layout 134. Information section 132 may be positioned within label 110 to provide adequate space for text-based content while preserving the visual impact of identifier section 128 and branding section 130. Information section 132 may accommodate various text sizes, formatting options, and content types through flexible layout parameters that ensure regulatory compliance while supporting identification functionality.

Information section 132 may include provisions for variable content that changes based on container contents, regulatory requirements, or product specifications while maintaining consistent positioning within three-section layout 134. In some cases, information section 132 incorporates machine-readable codes, nutritional information, or safety warnings that provide functional value beyond basic identification while utilizing the structured organization of three-section layout 134. Information section 132 may be configured through control unit 104 to automatically format and position informational content based on content length, regulatory requirements, and available space within label 110. Information section 132 may coordinate with database 107 to access standardized text templates and formatting specifications that ensure consistency and compliance across different container types and production batches within container labeling system 100.

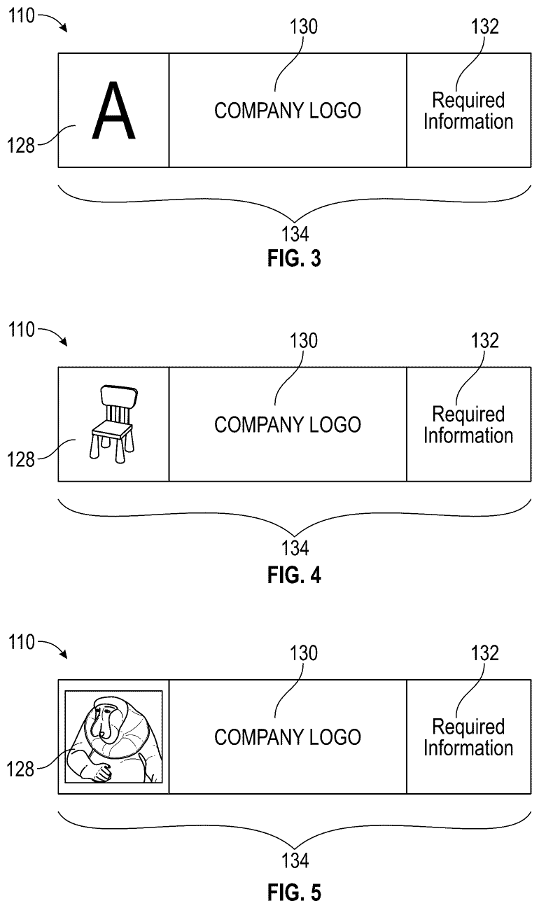

FIG. 3 through FIG. 6 show different types of label 110, in accordance with various embodiments of the present invention. Referring to FIG. 3, three-section layout 134 demonstrates adaptability across different visual identifier types while maintaining consistent organizational structure for brand presentation and informational content. Label 110 shown in FIG. 3 incorporates identifier section 128 containing the letter “A” as a textual identifier, while branding section 130 displays “COMPANY LOGO” text and information section 132 contains “Required Information” text. Here, identifier section 128 demonstrates how textual characters can serve as distinctive identification elements within the structured framework of three-section layout 134. The letter “A” or combination of letters provides immediate visual recognition through high-contrast presentation against the background of identifier section 128, enabling rapid identification without detailed examination of container surfaces. The size and positioning of the textual identifier within identifier section 128 maintains visibility across various viewing distances and lighting conditions that may occur in social gatherings or group environments. The simplicity of the single-letter identifier reduces cognitive load for users while providing sufficient distinctiveness to prevent accidental consumption between multiple users when containers are placed in shared spaces or group settings.

Branding section 130 maintains consistent positioning and proportional sizing relative to identifier section 128 and information section 132, demonstrating how three-section layout 134 preserves commercial branding visibility while accommodating identification functionality. The central placement of branding section 130 ensures brand elements remain prominent and recognizable to consumers while the identification elements in identifier section 128 provide the distinctive markings needed for container differentiation. Information section 132 provides adequate space for regulatory or product information without compromising the visual impact of either the identification or branding elements. This balanced arrangement within three-section layout 134 enables manufacturers to maintain brand recognition while providing users with effective container identification capabilities in social or commercial environments.

Referring to FIG. 4, label 110 incorporates a graphical icon or object within identifier section 128 that demonstrates how pictographic elements can provide distinctive visual identification within three-section layout 134 framework. The chair icon positioned in identifier section 128 creates immediate visual recognition through both color and shape characteristics that enable rapid identification in crowded social settings with varied lighting conditions. The pictographic approach within identifier section 128 provides advantages over text-based identifiers by enabling recognition across different literacy levels and age groups while maintaining visual distinctiveness under various environmental conditions. The chair icon demonstrates how everyday objects can serve as memorable identification elements that users can easily associate with their containers during social gatherings or group events where multiple similar containers may be present. The size and positioning of the pictographic element within identifier section 128 ensures visibility from typical viewing distances while maintaining proportional balance with branding section 130 and information section 132. The graphical nature of the identifier reduces language barriers and provides intuitive recognition that supports container identification across diverse user populations in social or group environments.

As further shown in FIG. 4, branding section 130 and information section 132 maintain consistent formatting and positioning relative to the pictographic identifier in identifier section 128, demonstrating the flexibility of three-section layout 134 to accommodate different identifier types while preserving functional organization. The “COMPANY LOGO” text in branding section 130 remains clearly visible and maintains brand recognition value despite the presence of the distinctive pictographic identifier in identifier section 128. Information section 132 continues to provide space for “Required Information” text while the overall label 110 maintains visual balance and readability across all three sections. This consistency in layout structure enables manufacturers to utilize various identifier types within identifier section 128 while maintaining standardized branding and informational content presentation across different product lines or container applications.

Referring to FIG. 5, label 110 demonstrates how animal imagery can serve as distinctive pictographic identifiers within identifier section 128 while maintaining the organizational framework of three-section layout 134. The monkey image positioned in identifier section 128 provides memorable visual identification that enables immediate recognition through familiar animal characteristics that users can easily remember and associate with their containers. The animal-based identifier approach within identifier section 128 creates engaging visual elements that may appeal to users across different age groups while providing distinctive markings that prevent accidental consumption between multiple users in group environments. The recognizable characteristics of the monkey image create multiple visual reference points including shape, posture, and facial features that support identification reliability even when viewing conditions may be suboptimal or when users may be distracted by social activities. The positioning and sizing of the animal identifier within identifier section 128 maintains visual prominence while preserving the functional balance of three-section layout 134 across branding section 130 and information section 132. The biological familiarity of animal imagery may reduce identification errors and support consistent container recognition across extended periods of use in social gatherings or group events where containers may be set aside and retrieved multiple times.

With continued reference to FIG. 5, three-section layout 134 maintains structural consistency while accommodating the animal-based pictographic identifier, demonstrating how the organizational framework adapts to different visual content types without compromising functional effectiveness. Branding section 130 continues to display “COMPANY LOGO” text with consistent formatting and positioning that preserves brand visibility alongside the distinctive animal identifier in identifier section 128. Information section 132 provides adequate space for “Required Information” text while the overall label 110 maintains readability and visual organization across all content areas. This adaptability of three-section layout 134 enables the accommodation of diverse identifier types including textual, symbolic, and pictographic elements while maintaining consistent brand presentation and informational content organization across different container applications and user scenarios.

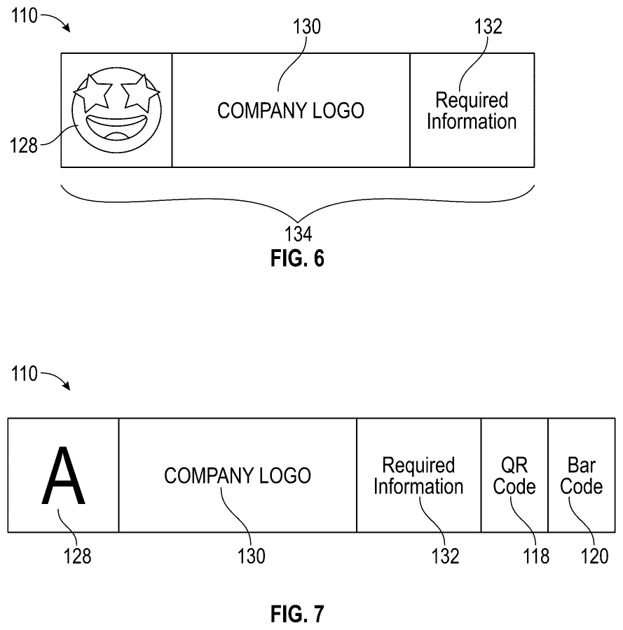

Referring to FIG. 6, label 110 incorporates an emoji symbol within identifier section 128 that demonstrates how contemporary digital iconography can provide distinctive identification elements within three-section layout 134 framework. The emoji positioned in identifier section 128 creates immediate visual recognition through familiar digital communication symbols that may resonate with users accustomed to electronic messaging and social media platforms. The integration of emoji-based identifiers within three-section layout 134 demonstrates how traditional labeling frameworks can accommodate contemporary visual elements while maintaining functional organization and brand presentation capabilities. Branding section 130 continues to provide space for “COMPANY LOGO” text with consistent formatting that preserves commercial value while the emoji identifier in identifier section 128 provides distinctive visual identification. Information section 132 maintains adequate space for “Required Information” text while the overall label 110 preserves visual balance and readability across all sections of three-section layout 134. This integration capability enables container labeling systems to incorporate evolving visual languages and cultural references while maintaining standardized organizational structures that support both identification functionality and commercial branding requirements across diverse user populations and social environments.

Identifier section 128 demonstrates versatility in accommodating various identification elements as shown across the figures, where identifier section 128 displays a letter in FIG. 3, an icon in FIG. 4, an animal image in FIG. 5, and an emoji in FIG. 6. In some aspects, identifier section 128 may accommodate additional identification elements including numbers, objects, pictures, thermal impressions, color coding, attachable labels, stickers, or combinations thereof without departing from the scope of the present invention. The adaptable nature of identifier section 128 enables implementation of diverse visual and tactile identification methods that may be selected based on user preferences, environmental conditions, or application requirements. In some cases, identifier section 128 may incorporate multiple identification elements simultaneously, such as combining color coding with pictographic symbols or integrating thermal impressions with textual identifiers to create multi-layered identification systems. Such implementations that utilize various identification elements within identifier section 128 fall within the scope of the present invention and demonstrate the flexible design capabilities of three-section layout 134 to accommodate evolving identification technologies and user interaction preferences while maintaining consistent organizational structure and functional effectiveness.

Referring to FIG. 7, label 110 having QR code 118 and barcode 120 is shown, in accordance with one exemplary embodiment of the present invention. The integration of QR code 118 and barcode 120 side-by-side within label 110 enables comprehensive digital tracking capabilities that extend from manufacturing through end-user interaction phases of container lifecycle management.

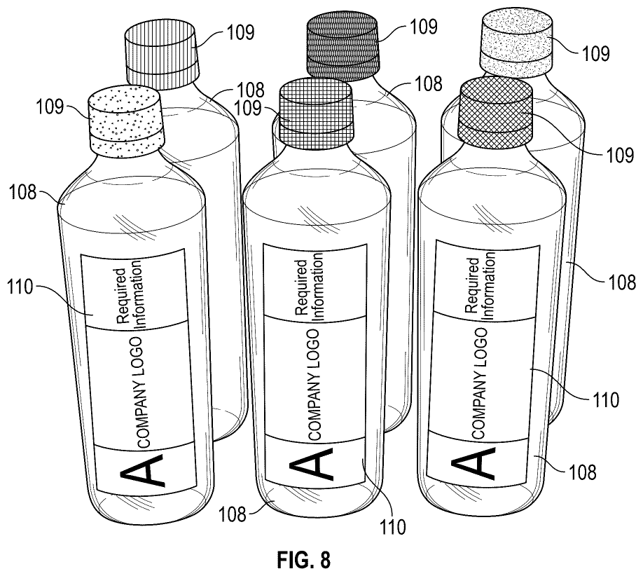

Referring to FIG. 8, multiple containers 108, each having a different color-coded caps 109 is shown, in accordance with one exemplary embodiment of the present invention. FIG. 8 is shown to demonstrate how color-coding systems on caps 109 can create immediate visual distinction between otherwise identical containers 108 through chromatic variation that enables rapid identification in social environments. Each cap 109 may be manufactured in different colors including red, blue, green, yellow, or other hues that provide sufficient visual contrast to enable reliable identification under various lighting conditions encountered in social gatherings, parties, or group events. Caps 109 may be formed from plastic, metal, or composite materials that accommodate color application through molding processes, coating applications, or material selection that creates permanent color characteristics resistant to fading or wear during handling and use.

The visual differentiation system implemented through caps 109 enables users to distinguish between similar containers 108 without requiring detailed examination of container surfaces or complex identification procedures. In some cases, caps 109 incorporate different color combinations or patterns that expand the available identification options beyond single-color schemes, enabling larger groups of users to maintain distinct container identification. The color-coding approach through caps 109 provides intuitive identification that requires minimal cognitive processing while maintaining effectiveness across different age groups and visual capabilities within group environments.

The combination of color-coded caps 109 and distinctive labels 110 creates a multi-layered identification system that provides redundant recognition pathways for users in group settings where container mix-ups commonly occur. Containers 108 benefit from both the immediate visual recognition provided by colored caps 109 and the detailed identification capabilities offered by labels 110 that may include pictographic elements, textual identifiers, or other distinctive markings. Labeling unit 102 within container labeling system 100 may coordinate the application of labels 110 with the color selection of caps 109 to create systematic identification schemes that prevent duplication while maximizing visual distinctiveness across container populations. Control unit 104 may manage the assignment of color and label combinations through algorithms that ensure each container 108 within a production batch or user group receives unique identification characteristics that prevent confusion during social interactions.

The multi-container implementation shown in FIG. 8 demonstrates how container labeling system 100 addresses practical challenges encountered in social environments where multiple users may have containers with similar appearances. Database 107 may store records of color and label combinations that have been assigned to specific containers 108, enabling tracking and verification of identification assignments across production batches or user groups. The systematic approach to multi-container identification through coordinated caps 109 and labels 110 reduces the likelihood of accidental consumption, minimizes waste from discarded containers due to ownership uncertainty, and supports hygiene practices by preventing inadvertent sharing of containers between users in group settings.

The comprehensive manufacturing and technological capabilities described above enable the versatility of labeling system 100 through application-specific implementations tailored to diverse use environments and user requirements. Party setting configurations utilize bright, high-contrast visual identifiers with enhanced visibility features designed to facilitate easy identification in social environments with multiple similar containers 108. These configurations may emphasize visual pattern differentiation that may include color-coding, combined with engaging visual patterns and interactive elements that enhance social interaction and prevent drink mix-ups. The party setting implementations often incorporate reflective surfaces 126 to create engaging visual experiences that add entertainment value while maintaining practical identification functionality.

Hospital ward implementations require subdued appearance characteristics and medical-grade materials that comply with healthcare facility hygiene and safety requirements while maintaining reliable individual container identification. These configurations prioritize tactile identification elements 116 and machine-readable codes 118, 120 that support automated tracking and inventory management while minimizing visual distraction in clinical environments.

In some cases, the luminescent materials may include UV-reactive ink. UV-reactive ink is a type of ink that glows when exposed to ultraviolet (UV) light, also known as blacklight. This can make label 110 highly visible and distinctive in environments where blacklight is used, such as nightclubs or bars. For example, label 110 printed with UV-reactive ink may appear as a standard label under normal lighting conditions, but may glow brightly when under blacklight, making container 108 easily identifiable. This can be particularly useful in low-light environments, where traditional labels may be difficult to see.

In some embodiments, the UV-reactive ink may be used to print one or more elements on label 110, such as numbers, letters, characters, diagrams, pictures, pictograms, symbols, colors, shades, hues, marks, sounds, displays, icons, graphics, objects, lines, curves, text, dots, shapes, data, photographs, images, and/or other content. These elements may glow under blacklight, providing a unique and eye-catching identifier for container 108.

In other cases, the UV-reactive ink may be used to create hidden or secret messages on label 110. For instance, a message or design printed with UV-reactive ink may be invisible or barely visible under normal lighting conditions, but may become clearly visible when exposed to blacklight. This can add an element of surprise and engagement to label 110, enhancing the user experience.

In each of these embodiments, the use of UV-reactive ink can provide a unique and engaging way to identify containers 108, enhancing the visual appeal of label 110 and facilitating easy identification in various lighting conditions.

In some cases, the variable data may be displayed using E-ink displays powered by thin, flexible batteries. E-ink, or electronic ink, is a type of electronic display technology that mimics the appearance of regular ink on paper. Unlike traditional displays, which use a backlight to illuminate pixels, E-ink displays reflect light like ordinary paper, making them more comfortable to read and providing a wider viewing angle.

The E-ink display may be integrated into label 110, providing a dynamic and changeable display of information. For instance, the E-ink display may show a unique serial number, batch number, or other identifier for each container 108. This identifier may be generated and assigned during the manufacturing process, ensuring that each container 108 has a unique identifier within the manufacturing batch.

In some aspects, the E-ink display may be powered by a thin, flexible battery integrated into label 110. This battery may provide the necessary power for the E-ink display to function, allowing the display to change and update as needed. The use of a thin, flexible battery allows label 110 to maintain a slim profile, ensuring that it does not add significant bulk or weight to container 108.

In other cases, the E-ink display may be configured to display other types of variable data, such as the date and time of manufacture, the expiration date of the product, or other product-specific information. This can provide valuable information to the consumer, enhancing the user experience and providing a high level of transparency about the product.

In each of these embodiments, the use of E-ink displays and variable data can provide a unique and engaging way to identify containers 108, enhancing the user experience and facilitating easy identification in various settings.

In some aspects, label 110 may incorporate unique patterns or designs to provide a distinctive visual appearance. For instance, holographic printing techniques may be employed to create 3D-like images on label 110. Holographic printing involves the use of laser technology to create a light field that simulates a three-dimensional image on a two-dimensional surface. When viewed from different angles, the holographic image appears to change, providing a dynamic and eye-catching visual effect. In some cases, the holographic image may be used to depict one or more elements on label 110, such as numbers, letters, characters, diagrams, pictures, pictograms, symbols, colors, shades, hues, marks, sounds, displays, icons, graphics, objects, lines, curves, text, dots, shapes, data, photographs, images, and/or other content. This can create a unique and visually appealing identifier for container 108, enhancing the aesthetic attributes of label 110 and facilitating easy identification.

In other embodiments, lenticular printing techniques may be used to create labels 110 with images that appear to move or change as the viewing angle shifts. Lenticular printing involves the use of a lenticular lens to create an illusion of depth, or to make an image appear to move or change when viewed from different angles. This can create a dynamic and engaging visual effect, enhancing the visual appeal of label 110. In some cases, the lenticular image may depict one or more elements on label 110, such as numbers, letters, characters, diagrams, pictures, pictograms, symbols, colors, shades, hues, marks, sounds, displays, icons, graphics, objects, lines, curves, text, dots, shapes, data, photographs, images, and/or other content. This can provide a unique and visually engaging identifier for container 108, enhancing the aesthetic attributes of label 110 and facilitating easy identification.

In each of these embodiments, the use of holographic or lenticular printing techniques can provide a unique and engaging way to identify containers 108, enhancing the visual appeal of label 110 and facilitating easy identification in various lighting conditions.

In some embodiments, label 110 may incorporate thermochromic materials that change color in response to temperature variations. Thermochromic materials are substances that change their color as a result of a change in temperature. This property can be utilized in the label design to provide a functional aspect to label 110, enhancing the user experience.

In some cases, label 110 may be made from temperature-sensitive materials that change color when container 108 reaches an optimal drinking temperature. For instance, a label 110 on a container 108 holding a hot beverage such as coffee or tea may change color when the beverage reaches a temperature that is safe for consumption. This can provide a visual indicator to the user, informing them when the beverage is at the ideal temperature for consumption. This can enhance user convenience and safety, reducing the risk of burns from consuming beverages that are too hot.

In other cases, label 110 on container 108 holding a chilled beverage may change color when the beverage reaches a temperature that is optimal for taste and refreshment. For example, label 110 on container 108 holding a beer or soda may change color when the beverage is chilled to the ideal serving temperature. This can provide a visual indicator to the user, informing them when the beverage is at the ideal temperature for enjoyment. This can enhance the user experience, ensuring that beverages are consumed at their optimal temperatures for taste and refreshment.

In each of these embodiments, the use of thermochromic materials in the label design can provide a unique and functional way to identify containers 108, enhancing the user experience and facilitating easy identification in various settings.

In some embodiments, label 110 may incorporate tactile markings or textures to enhance the sensory experience of the user. These tactile markings or textures may be integrated into the label design, providing a physical element that users can feel with their fingers. This can add a tactile dimension to label 110, enhancing user engagement and providing an additional layer of identification beyond visual elements.

In some cases, the tactile markings or textures may be created using embossing or debossing techniques. Embossing involves raising certain areas of label 110 to create a three-dimensional effect, while debossing involves pressing certain areas of label 110 to create indented patterns. These techniques can create a variety of tactile effects, such as ridges, grooves, bumps, or patterns, that users can feel when they touch label 110. This can provide a unique and engaging way to identify containers 108, enhancing the user experience and facilitating easy identification in various settings.

In yet other cases, engraving techniques may be employed. Engraving is a process that uses a machine to cut into the surface of label 110, creating a permanent design. This method may be particularly useful for labels made from durable materials such as metal or plastic, as it creates a long-lasting and resistant mark.

In each of these embodiments, the choice of technique for applying elements to the container labels may depend on the complexity of the design, the type of material used for the label, and the desired visual or tactile effect. This allows for a high degree of customization, enabling each label to be uniquely tailored to its specific container and application.

In some aspects, the elements on label 110 may be configured to convey information about the contents, origin, quality, or manufacturing process of the container. For instance, label 110 may include text or symbols indicating the type of beverage contained within, such as “coffee,” “tea,” “soda,” or “water.” This can help users to quickly identify the contents of the container, reducing confusion and enhancing user experience. In some cases, label 110 may also include branding information, such as the logo or name of the beverage manufacturer. This can increase brand visibility and recognition, potentially enhancing customer loyalty and market share.

In other embodiments, label 110 may include usage instructions for the container or its contents. For example, label 110 may include instructions on how to open the container, how to store the beverage for optimal freshness, or how to properly dispose of the container after use. This can enhance user convenience and promote responsible consumption and disposal practices.

In other cases, label 110 may incorporate scratch-off areas. Scratch-off areas are sections of label 110 that are covered with a removable layer, typically made from a latex-based material. Users can scratch off this layer using a coin or their fingernail, revealing hidden information or designs underneath. This can add an interactive element to label 110, enhancing user engagement and providing a fun and engaging way to identify containers 108. For example, a scratch-off area on a label 110 may reveal a unique pattern, color, or message that serves as a unique identifier for container 108. This can provide a unique and engaging way to identify containers 108, enhancing the user experience and facilitating easy identification in various settings.

In some cases, label 110 may include QR code 118 or barcode 120 that can be scanned using a smartphone or other device. QR code 118 or barcode 120 may link to a website or app that provides additional information about container 108 or its contents. For example, QR code 118 may link to a webpage providing detailed nutritional information about the beverage, instructions on how to recycle container 108, or promotional content such as discounts or loyalty rewards. This can enhance user engagement and provide a digital interaction component to the physical container 108.

In some aspects, QR code 118 or barcode 120 may also serve as a unique identifier for container 108. Each container 108 may have a unique QR code 118 or barcode 120 that can be scanned to verify the authenticity of the product, track the product through the supply chain, or provide other product-specific information. This can enhance product traceability, deter counterfeiting, and provide valuable data for inventory management and other business operations.

In other embodiments, label 110 may include information about the origin of the product. This could include information about where the product was manufactured, the source of the ingredients, or the location of the company that produced the product. This information can be particularly important for consumers who are interested in supporting local businesses, or who want to ensure that their products are sourced from ethical and sustainable sources.

In some cases, label 110 may include information about the quality of the product. This could include information about the grade or quality of the ingredients used, the manufacturing standards adhered to, or any certifications or awards that the product has received. This information can be particularly important for consumers who are concerned about the quality and safety of the products they consume.

In other aspects, label 110 may include information about the manufacturing process of the product. This could include information about the methods used to produce the product, the equipment used, or the environmental impact of the manufacturing process. This information can be particularly important for consumers who are interested in the sustainability and environmental impact of the products they consume.

In each of these embodiments, the elements on label 110 serve to convey important information to the consumer, enhancing the user experience and providing valuable information about the product.

Turning to the configuration of elements based on container type, size, shape, or material, in some aspects, label 110 may be designed as a wraparound label that covers the entire circumference of container 108. This type of label, also known as a full-wrap label, may provide more space for the placement of identifiers and information, enhancing the visibility and readability of label 110. The wraparound label may be particularly suitable for cylindrical or round containers 108, such as bottles or cans, where label 110 can be wrapped around the entire body of container 108 to provide a continuous and seamless appearance. In some cases, the wraparound label may be secured to container 108 using adhesive or other attachment methods, ensuring a secure and durable fit.

In other embodiments, label 110 may be designed as a die-cut label in unique shapes. Die-cutting is a process that uses a die, which is a sharp, custom-shaped tool, to cut the label material into specific shapes. The shape of the die-cut label may be chosen to match the shape of container 108, to align with the branding or aesthetic preferences of the manufacturer, or to create a distinctive visual identifier for container 108. For instance, a label 110 for a container 108 in the shape of a star, an animal, or a brand-specific design may be die-cut to match the shape of container 108, providing a unique and visually appealing identifier for container 108. This can enhance the aesthetic attributes of container 108 and facilitate easy identification in various settings.

In each of these embodiments, the configuration of label 110 and its elements may be tailored based on the type, size, shape, or material of container 108. This allows for a high degree of customization, enabling each label 110 to be uniquely tailored to its specific container 108 and application. This can enhance the visual appeal of container 108, facilitate easy identification, and provide a tailored labeling solution for each type of container 108.

In some embodiments, the elements on label 110 may be configured to enable product differentiation, tracking, or anti-counterfeiting measures. For instance, each container label 110 may have a unique QR code 118 or barcode 120 that can be scanned to verify the authenticity of the product, track the product through the supply chain, or provide other product-specific information. This can enhance product traceability, deter counterfeiting, and provide valuable data for inventory management and other business operations.

In some cases, the elements on label 110 may include unique patterns or designs that distinguish one product from another. For example, a label 110 for a particular brand of soda may have a unique color pattern or geometric design that distinguishes it from other brands of soda. This can enhance product differentiation, making it easier for consumers to identify and choose their preferred products in a crowded marketplace.

In other aspects, the elements on label 110 may include security features 124 designed to deter counterfeiting. For instance, label 110 may include holographic images, microtext, or other security features 124 that are difficult to replicate. These security features 124 can be verified using specialized equipment or techniques, providing a reliable way to authenticate the product and deter counterfeiting.

In some embodiments, the elements on label 110 may include tracking codes or identifiers that enable the tracking of the product through the supply chain. For example, a label 110 may include a unique serial number, batch number, or other identifier that can be used to track the product from the manufacturing facility to the retail store. This can provide valuable data for inventory management, supply chain optimization, and other business operations.

In each of these embodiments, the elements on label 110 serve to enable product differentiation, tracking, or anti-counterfeiting measures, enhancing the functionality of labels 110 and providing valuable benefits for manufacturers, retailers, and consumers.

In some embodiments, label 110 may incorporate variable data, allowing each container label 110 to be unique within a manufacturing batch. This can provide a high level of customization, enabling each container 108 to have a unique identifier that distinguishes it from all other containers 108 in the same batch. This can be particularly useful in scenarios where individual tracking or identification of containers 108 is required.

In some embodiments, label 110 may incorporate visually distinct patterns for easy identification and differentiation of containers 108. These patterns may be created using various design techniques and may include geometric shapes, lines, curves, dots, or other visual elements. The patterns may be arranged in a multitude of ways to create unique identifiers for each container 108, enhancing the visual appearance of container 108 and facilitating easy identification.

In some cases, the visually distinct patterns may utilize color-coding (which may be represented as different patterns or shadings in the figures), with each color or pattern representing a different type of beverage or product. For instance, a red pattern may be used for containers 108 holding cola, while a green pattern may be used for containers 108 holding lemon-lime soda. This can provide a quick and intuitive way for users to identify the contents of container 108, reducing confusion and enhancing user experience.

In other aspects, the visually distinct patterns may be designed to reflect the branding or aesthetic preferences of the manufacturer. For instance, label 110 for a particular brand of soda may have a unique pattern that aligns with the brand's logo or color scheme. This can enhance brand visibility and recognition, potentially enhancing customer loyalty and market share.

In some embodiments, the visually distinct patterns may be created using special printing techniques, such as holographic printing, lenticular printing, or UV-reactive printing. These techniques can create dynamic and eye-catching visual effects, enhancing the visual appeal of label 110 and facilitating easy identification in various lighting conditions.

In other cases, the visually distinct patterns may be tactile, providing a physical element that users can feel with their fingers. This can add a tactile dimension to label 110, enhancing user engagement and providing an additional layer of identification beyond visual elements.

In each of these embodiments, the use of visually distinct patterns can provide a unique and engaging way to identify containers 108, enhancing the user experience and facilitating easy identification in various settings.

Turning to the incorporation of machine-readable codes for automated sorting, tracking, and inventory management, in some aspects, label 110 may include machine-readable codes, such as barcodes 120, QR codes 118, or RFID tags. These codes can be scanned using a barcode scanner, a smartphone, or other scanning devices, providing a quick and efficient way to identify container 108 and access information about its contents.

In some cases, the machine-readable codes may be used for automated sorting of containers 108. For instance, in a manufacturing or distribution facility, containers 108 may be sorted based on the information encoded in their machine-readable codes. This can streamline the sorting process, reducing manual labor and improving operational efficiency.

In other embodiments, the machine-readable codes may be used for tracking containers 108 through the supply chain. Each container 108 may have a unique code that can be scanned at various points in the supply chain, from the manufacturing facility to the retail store. This can provide real-time tracking information, enabling manufacturers and retailers to monitor the movement of containers 108 and manage their inventory more effectively.

In some aspects, the machine-readable codes may also be used for inventory management. For instance, a retailer may scan the codes on containers 108 to quickly count the number of containers 108 in stock, or to check the sell-by dates of perishable products. This can improve inventory accuracy, reduce the risk of stockouts or overstocking, and ensure the freshness of products.

In other cases, the machine-readable codes may be used for anti-counterfeiting measures. Each container 108 may have a unique code that can be verified against a database 107 to ensure the authenticity of the product. This can deter counterfeiting, protect brand reputation, and ensure product quality and safety for consumers.

In each of these embodiments, the use of machine-readable codes can provide a versatile and efficient way to identify containers 108, enhancing operational efficiency and providing valuable benefits for manufacturers, retailers, and consumers.

In some embodiments, label 110 may incorporate a combination of visual and auditory elements, providing a multi-sensory identification system. For instance, label 110 may include a visual identifier, such as a unique color or pattern, as well as an auditory identifier, such as a unique sound or melody that is emitted when label 110 is scanned or interacted with. This can provide a rich and engaging user experience, enhancing user engagement and satisfaction.

In some cases, the auditory element may be generated by an embedded sound chip in label 110. The sound chip may be programmed to emit a specific sound or melody when activated, providing a unique auditory identifier for container 108. The sound chip may be activated by various means, such as by pressing a button on label 110, by scanning label 110 with a smartphone, or by opening container 108. This can provide a unique and engaging way to identify containers 108, enhancing the user experience and facilitating easy identification in various settings.

In other aspects, the auditory element may be a sound that is associated with the brand or product. For instance, a label 110 for a particular brand of soda may emit a sound that is associated with the brand's advertising jingle or theme song. This can enhance brand recognition and customer loyalty, potentially enhancing customer loyalty and market share.

In some embodiments, the auditory element may be a sound that is associated with the contents of container 108. For instance, a label 110 for a container 108 holding a carbonated beverage may emit a sound that mimics the sound of a carbonated beverage being opened or poured. This can provide a fun and engaging way to identify the contents of container 108, enhancing the user experience and facilitating easy identification in various settings.

In each of these embodiments, the use of a combination of visual and auditory elements can provide a unique and engaging way to identify containers 108, enhancing the user experience and facilitating easy identification in various settings.

Turning to the system for manufacturing container labels 110, in some aspects, labeling unit 102 may be equipped with one or more applicators 106 for applying one or more elements onto each container label 110. These elements may be selected from the group consisting of numbers, letters, characters, diagrams, pictures, pictograms, symbols, colors, shades, hues, marks, sounds, displays, icons, graphics, objects, lines, curves, text, dots, shapes, data, photographs, images, and/or other content. Applicators 106 may be configured to apply these elements in various ways, such as by printing, embossing, debossing, or engraving, depending on the desired visual or tactile effect.

In some cases, labeling unit 102 may be equipped to produce multi-part labels with a removable section. These labels 110 may include a main section that remains attached to container 108, and a removable section that can be detached from the main section. The removable section may include additional identifiers or information, or may be used for promotional purposes. For instance, the removable section may include a coupon, a loyalty reward code, or other promotional content that can be kept by the user after container 108 is discarded.

In other embodiments, labeling unit 102 may be equipped to produce expandable labels that unfold to reveal additional information or larger identifiers. These labels 110 may include a folded section that can be unfolded by the user to reveal hidden identifiers or information. For instance, the folded section may include detailed nutritional information, usage instructions, or promotional content that is not visible when label 110 is in its folded state. This can provide a larger surface area for the placement of identifiers and information, enhancing the visibility and readability of label 110.

In some aspects, labeling unit 102 may be equipped to produce magnetic labels that can be easily removed and reattached to container 108. These labels 110 may include a magnetic layer that allows label 110 to adhere to container 108 without the need for adhesive. The magnetic layer may be strong enough to keep label 110 securely attached to container 108 during normal use, but weak enough to allow label 110 to be easily removed and reattached by the user. This can provide a reusable and customizable labeling solution, allowing users to easily change the identifiers on their containers 108 as needed.

In other cases, labeling unit 102 may be equipped to produce silicone bands with printed or embossed identifiers. These bands may be stretchable and resilient, allowing them to fit around various container sizes and shapes. The identifiers may be printed or embossed onto the silicone bands, providing a durable and water-resistant labeling solution. This can be particularly useful for containers 108 that are frequently handled or exposed to moisture, such as drink containers or personal care product containers.

In some embodiments, labeling unit 102 may be equipped to produce clip-on tags that attach to the rim or neck of containers 108. These tags may include a clip or other attachment mechanism that allows the tag to be easily attached to and detached from container 108. The identifiers may be printed or embossed onto the tags, providing a durable and reusable labeling solution. This can be particularly useful for containers 108 that are frequently reused, such as glass bottles or jars.

In other aspects, labeling unit 102 may be equipped to produce labels 110 with augmented reality markers. These markers may be scannable using a smartphone or other device equipped with an augmented reality app, allowing the user to access digital content or interactions related to container 108 or its contents. For instance, the augmented reality markers may link to a 3D animation, a video, a website, or other digital content that enhances the user experience or provides additional information about the product.

Control unit 104 may be configured to differentially configure the one or more elements on each container label 110 based on predetermined criteria. For instance, control unit 104 may adjust the size, color, position, or other attributes of the elements based on the type, size, shape, or material of container 108, the contents of container 108, or other factors. This can provide a high degree of customization, enabling each label 110 to be uniquely tailored to its specific container 108 and application.

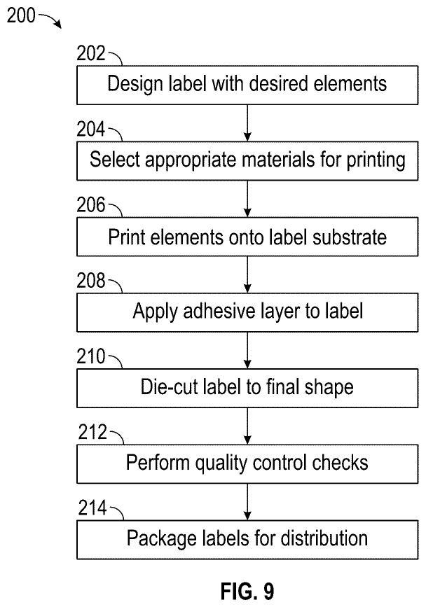

Now referring to FIG. 9, a method 200 for manufacturing labels that enable visual or tactile distinction between otherwise similar-looking containers is explained, in accordance with one exemplary embodiment of the present invention. Method 200 may be described in the general context of manufacturing processes and quality control procedures. Generally, manufacturing processes may include design development, material selection, printing operations, adhesive application, cutting procedures, quality verification, and packaging operations that create finished label products with distinctive identification capabilities. Method 200 may also be practiced in distributed manufacturing environments where operations are performed by multiple facilities that are coordinated through production management systems. In a distributed manufacturing environment, process specifications and quality standards may be maintained across both local and remote manufacturing locations, including automated and manual production systems.

The order in which method 200 is described is not intended to be construed as a limitation, and any number of the described method blocks can be combined in any order to implement method 200 or alternate methods. Additionally, blocks may be deleted from method 200 without departing from the scope of the invention described herein. Furthermore, the method may be implemented using any suitable manufacturing equipment, automated systems, manual processes, or combination thereof. However, for case of explanation, in the embodiments described below, method 200 may be implemented within the above-described container labeling system 100.

Method 200 begins at step 202. At step 202, container labeling system 100 designs label 110 with distinctive elements for container identification in social environments. Container labeling system 100 creates visual elements 112 including colors, patterns, symbols, and pictographic representations through graphic design software. Container labeling system 100 establishes identification specifications based on purpose, size, shape, and intended application. In some cases, container labeling system 100 uses graphic design software to create visual elements 112 of label 110, including text, images, and branding information. Container labeling system 100 incorporates input from control unit 104 to align design specifications with identification requirements, production capabilities, and quality standards. The design specifications include heat-shrink sleeves made from thermoplastic material, wraparound label designs for cylindrical containers, and die-cut label designs in unique shapes.

At step 204, container labeling system 100 selects appropriate materials for printing or embedding distinctive elements. Container labeling system 100 evaluates various substrate options including paper, vinyl, polyester, and specialty materials that provide durability, flexibility, and compatibility with different container materials. Container labeling system 100 selects material for label 110 considering factors such as durability, environment, and the surface it will adhere to. Container labeling system 100 selects from common label materials including paper, vinyl, polyester, and specialty materials like holographic or metallic substrates. Container labeling system 100 assesses thermoplastic materials for heat-shrink sleeve applications, adhesive specifications for wraparound labels, and specialty cutting materials for die-cut labels that enable precise shaping without compromising material integrity.

At step 206, container labeling system 100 prints and renders distinctive elements onto label substrates. Container labeling system 100 prepares the digital design for printing through the prepress process, including color calibration to match intended colors. Container labeling system 100 implements digital printing processes for complex designs, flexographic printing for high-volume production runs, or offset printing for applications requiring high-quality color reproduction. Container labeling system 100 chooses printing methods based on the label's complexity and quantity, with digital printing for short runs and intricate designs, and flexographic printing for high-volume production. Container labeling system 100 translates the design onto the selected material using inks, toners or other materials. In some cases, container labeling system 100 employs thermal printing for labels 110 that require variable data, such as barcodes 120 or QR codes 118. Container labeling system 100 may use embossing or debossing techniques to create tactile markings or textures on label 110. Container labeling system 100 accommodates specialized techniques for heat-shrink sleeve applications, wraparound labels that create seamless design continuity, and die-cut labels with properly positioned design elements.

At step 208, container labeling system 100 applies adhesive layers to create bonding capabilities between label substrates and container surfaces. In some cases, container labeling system 100 applies the adhesive layer to label 110 after printing. Container labeling system 100 uses pressure-sensitive adhesives that form a bond when slight pressure is applied, or heat-activated or solvent-activated adhesives for specific applications. Container labeling system 100 precisely coats the adhesive layer onto the material in a controlled environment to ensure uniformity. Container labeling system 100 selects adhesive types based on the label's intended use i.e., whether it needs to stick to various surfaces, withstand moisture, or be easily removable without leaving residue. Container labeling system 100 implements pressure-sensitive adhesive applications for standard labeling, heat-activated adhesives for specialized bonding, or removable adhesive formulations for reusable labels. Container labeling system 100 includes specialized processes for heat-shrink sleeves with temporary positioning capabilities, wraparound labels with secure bonding across curved surfaces, and die-cut labels with secure attachment across unique shapes.

At step 210, container labeling system 100 implements die cutting operations that create final label shapes and dimensions. Container labeling system 100 cuts label 110 to its final shape through die cutting, using a sharp tool in the desired label shape that cuts through the material while avoiding damage to the adhesive layer. Container labeling system 100 applies finishing processes like lamination, varnishing, or embossing to enhance the label's appearance, durability, and tactile qualities. Container labeling system 100 employs rotary die cutting for high-volume production, flatbed die cutting for complex shapes and specialty materials, or laser cutting for intricate designs requiring high precision. Container labeling system 100 accommodates specialized processes for heat-shrink sleeves accounting for material properties, wraparound labels with precise length dimensions, and die-cut labels in unique shapes that maintain design integrity. In some embodiments, container labeling system 100 uses heat-shrink sleeves as labels 110 that conform to the shape of container 108 when heated, providing a seamless appearance. Container labeling system 100 applies the heat-shrink sleeve to container 108 in a heat tunnel, where the sleeve shrinks to fit the container's shape.

At step 212, container labeling system 100 employs quality control procedures to verify label specifications and performance. Container labeling system 100 conducts rigorous quality control checks, inspecting for accurate colors, correct shapes, proper adhesive application, and any defects. Container labeling system 100 implements automated inspection systems that detect printing defects, cutting irregularities, and adhesive application inconsistencies through optical scanning and measurement technologies. Container labeling system 100 includes specialized assessments for heat-shrink sleeves verifying shrinkage characteristics, wraparound labels assessing adhesive bonding strength and edge alignment, and die-cut labels verifying shape accuracy and design positioning across unique configurations.

At step 214, container labeling system 100 updates packaging operations that prepare finished labels for distribution and application. Container labeling system 100 packages labels 110 that pass inspection in rolls, sheets, or individual units, depending on the application and client's requirements. Container labeling system 100 carefully chooses packaging to prevent damage during transit and storage. Container labeling system 100 organizes information through protective packaging methods that maintain label quality during transportation while providing clear organization and accessibility for application procedures. Container labeling system 100 accommodates specialized requirements for heat-shrink sleeves that protect material properties and prevent premature shrinkage, wraparound labels that prevent adhesive contamination, and die-cut labels that protect unique shapes and prevent damage to intricate design elements.

Upon completion of method 200, container labeling system 100 transitions to a completion state where finished labels 110 are ready for distribution and application. Container labeling system 100 manufactures container labels 110 by providing a plurality of containers 108, applying one or more elements onto each container label 110, and differentially configuring these elements based on predetermined criteria. Container labeling system 100 selects elements from numbers, letters, characters, diagrams, pictures, pictograms, symbols, colors, shades, hucs, marks, sounds, displays, icons, graphics, objects, lines, curves, text, dots, shapes, data, photographs, images, and other content. Container labeling system 100 applies these elements using various techniques including printing, thermal printing, embossing, debossing, or engraving based on design complexity, material type, and desired visual effect. Container labeling system 100 includes information related to contents, origin, quality, or manufacturing process on each container label 110. Container labeling system 100 makes labels available for both pre-sale manufacturing applications and post-sale scenarios where labels are manufactured for end-user application after container purchase. Container labeling system 100 stores finished labels with comprehensive documentation including application instructions, storage requirements, and identification information that support effective container identification in social environments.

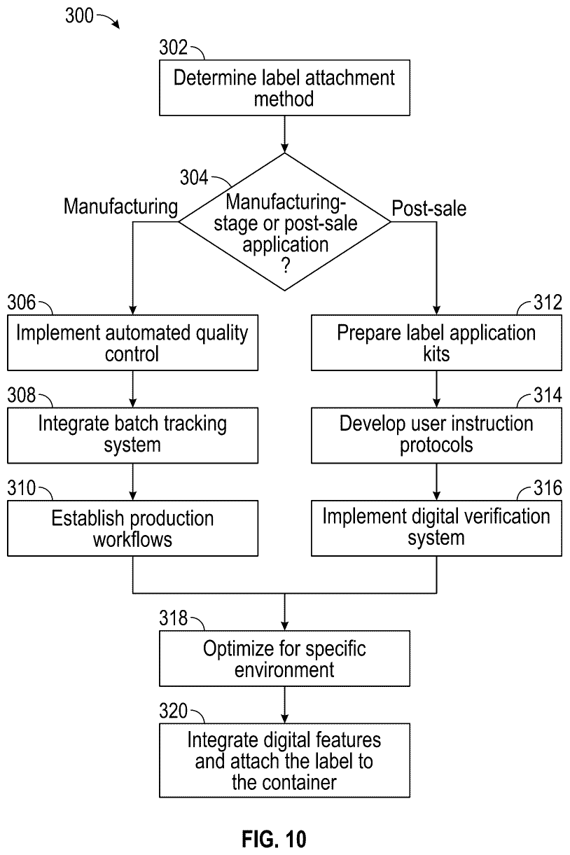

Now referring to FIG. 10, a method 300 for determining and implementing label attachment methods across both manufacturing and post-sale application scenarios is explained, in accordance with one exemplary embodiment of the present invention. Method 300 may be described in the general context of decision-making frameworks and implementation processes. Generally, decision-making processes may include evaluation procedures, pathway selection, quality control protocols, tracking system integration, workflow establishment, kit preparation, instruction development, digital verification, environmental optimization, and feature integration that create comprehensive attachment solutions. Method 300 may also be practiced in hybrid environments where both manufacturing-stage and post-sale applications are coordinated through integrated management systems.

Method 300 begins at step 302. At step 302, container labeling system 100 determines optimal label attachment methods based on container characteristics, application timing, and user requirements. Container labeling system 100 analyzes container materials, surface properties, and geometric configurations to establish compatibility requirements for different attachment methods. Container labeling system 100 may evaluate adhesive bonding, mechanical fastening, and specialized application techniques for various container types. In some cases, container labeling system 100 establishes specifications for multi-part labels with removable sections, expandable labels that unfold to reveal additional information, and magnetic labels that can be easily removed and reattached. Container labeling system 100 also considers silicone bands with printed or embossed identifiers as potential attachment solutions for specific container types.

At step 304, container labeling system 100 evaluates whether label attachment will occur during manufacturing stages or through post-sale application by end users. Container labeling system 100 assesses production schedules, distribution timelines, and user preferences to determine the most suitable application timing. In some cases, container labeling system 100 considers container types, content specifications, event requirements, and timing constraints when determining appropriate application pathways. Container labeling system 100 routes the process through either manufacturing-focused or post-sale implementation steps based on this evaluation.

If it is determined at step 304 that the label needs to be attached at the manufacturing stage, then method 300 moves to step 306. At step 306, container labeling system 100 implements automated quality control systems that monitor attachment processes during manufacturing. Container labeling system 100 establishes quality control protocols that examine attachment strength, positioning accuracy, and visual appearance of labels. Container labeling system 100 uses automated inspection systems that detect attachment defects and performance inconsistencies throughout the production process. In some cases, container labeling system 100 verifies separation mechanisms for multi-part labels, folding mechanisms for expandable labels, and magnetic bonding strength for magnetic labels. Container labeling system 100 also tests stretchability characteristics for silicone bands to ensure consistent performance across production batches.

At step 308, container labeling system 100 integrates batch tracking systems that monitor container identification assignments. Container labeling system 100 coordinates with database 107 to store tracking information that enables traceability across different production runs. Container labeling system 100 maintains comprehensive production records that support verification and quality assurance processes. In some cases, container labeling system 100 monitors separation mechanism performance for multi-part labels, folding mechanism functionality for expandable labels, and bonding strength consistency for magnetic labels. Container labeling system 100 also tracks stretchability characteristics for silicone bands to ensure consistent performance across manufacturing batches.

At step 310, container labeling system 100 establishes manufacturing workflows that integrate attachment methods with existing production processes. Container labeling system 100 coordinates attachment operations with container production schedules, material handling systems, and quality control checkpoints. Container labeling system 100 ensures seamless integration within manufacturing workflows to maintain production efficiency. In some cases, container labeling system 100 coordinates separation mechanism installation for multi-part labels, folding operations for expandable labels, and magnetic component installation for magnetic labels. Container labeling system 100 also integrates identifier application processes for silicone bands within the overall manufacturing sequence.

If it is determined at step 304 that the label needs to be attached through post-sale application by end users, then method 300 moves to step 312. At step 312, container labeling system 100 prepares label application kits that enable the end users to apply identification labels after purchase. Container labeling system 100 assembles the application kits that include pre-designed labels, application tools, and instruction materials. Container labeling system 100 includes quality verification components that support user-friendly attachment processes. In some cases, container labeling system 100 provides separation tools and content customization options for multi-part labels, folding guides and content templates for expandable labels, and positioning guides for magnetic labels. Container labeling system 100 also includes sizing guides and identifier customization options for silicone bands to accommodate different container dimensions.

At step 314, container labeling system 100 develops user instruction protocols that provide clear guidance for label application. Container labeling system 100 creates instruction materials that include visual guides, step-by-step procedures, and troubleshooting information. Container labeling system 100 designs these materials to enable successful label application by users with varying technical experience levels. In some cases, container labeling system 100 provides guidance for separation mechanism operation for multi-part labels, folding procedures for expandable labels, and surface preparation requirements for magnetic labels. Container labeling system 100 also includes sizing procedures for silicone bands to ensure proper fit on different container types.

At step 316, container labeling system 100 implements digital verification systems that enable users to confirm proper label application. Container labeling system 100 establishes digital platforms that provide application verification through smartphone scanning and quality assessment feedback. Container labeling system 100 offers performance confirmation tools for user-applied labels to ensure correct attachment. In some cases, container labeling system 100 confirms separation mechanism functionality for multi-part labels, folding mechanism operation for expandable labels, and bonding strength for magnetic labels. Container labeling system 100 also verifies fit characteristics for silicone bands to ensure secure attachment to containers.

At step 318, container labeling system 100 optimizes attachment methods for specific environmental conditions and user requirements. Container labeling system 100 configures attachment methods for social or group environments including parties, schools, sporting events, and households. Container labeling system 100 conducts environmental assessment and optimization procedures that address identification challenges in different settings. In some cases, container labeling system 100 adapts separation mechanisms for multi-part labels, folding mechanisms for expandable labels, and bonding characteristics for magnetic labels. Container labeling system 100 also adjusts stretchability parameters for silicone bands based on specific social settings and user interaction requirements.

At step 320, container labeling system 100 integrates digital features and completes final attachment to containers. Container labeling system 100 incorporates machine-readable codes, tracking capabilities, and interactive content while finalizing physical attachment to container surfaces. Container labeling system 100 ensures secure bonding and proper positioning during this final implementation stage. In some cases, container labeling system 100 activates tracking systems for removable sections in multi-part labels, content tracking for expandable labels, and repositioning tracking for magnetic labels. Container labeling system 100 also implements identifier tracking for silicone bands to maintain comprehensive monitoring capabilities within the overall labeling system.

The dual-mode identification system represents a culmination of the technologies and approaches described throughout this disclosure, combining pre-manufactured identifiers applicd during production with user customization capabilities that allow post-manufacturing personalization. Pre-applied elements provide a permanent identification foundation that ensures each container 108 maintains unique characteristics, while user-customizable areas accommodate personal preferences, social group themes, or event-specific modifications. This combination addresses the limitations of prior art systems that provide either manufacturer-applied or user-applied identification, but not both in an integrated solution. The dual-mode approach leverages the manufacturing capabilities of container labeling system 100 while providing the flexibility that users require for personalization and social interaction, creating a comprehensive identification solution that serves both commercial and personal use cases effectively.

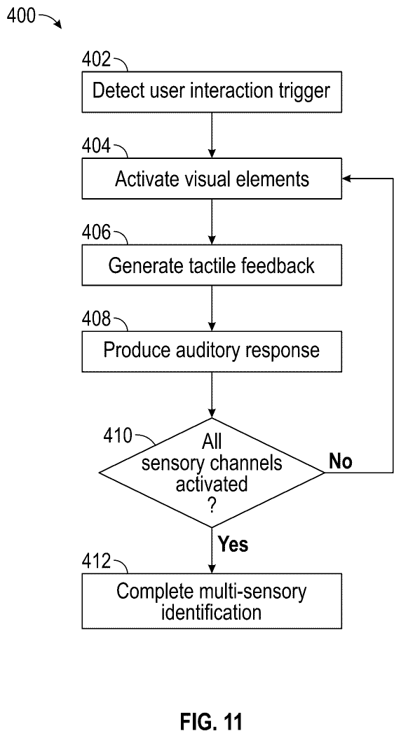

Now referring to FIG. 11, a method 400 for multi-sensory identification that coordinates visual, tactile, and auditory elements is explained, in accordance with one exemplary embodiment of the present invention. Method 400 may be described in the general context of sensory activation processes and user interaction systems. Generally, multi-sensory processes may include trigger detection, visual activation, tactile feedback generation, auditory response production, sensory channel evaluation, and identification completion that create enhanced container recognition capabilities. Method 400 may also be practiced in adaptive environments where sensory activation adjusts based on user capabilities and environmental conditions.

Method 400 begins at step 402. At step 402, user interaction triggers are detected to activate multi-sensory identification. Here, various interaction types including physical contact with container surfaces, proximity detection through sensor systems, and intentional activation through button presses or scanning operations are monitored. In some cases, label 110 detects triggers for embedded sound chips programmed to emit specific sounds when activated. Label 110 also uses proximity sensors that detect when users approach containers and optical scanning detection that recognizes when users position scanning devices near machine-readable codes.

At step 404, label 110 activates visual elements 12 that provide immediate visual feedback and identification information. Label 110 illuminates luminescent materials, activates color-changing thermochromic components, and triggers electronic displays that create distinctive visual signatures for individual containers. In some cases, label 110 activates reflective surfaces 126 that redirect ambient light and holographic elements that create dynamic visual effects. Label 110 also activates electronic displays for E-ink displays while coordinating with antimicrobial label materials that maintain hygienic conditions during visual interaction.

At step 406, label 110 generates tactile feedback that provides physical confirmation of container identification. Label 110 activates vibration mechanisms, temperature changes, and textural modifications that create distinctive physical sensations when users contact labeled container surfaces. In some cases, label 110 activates shape-memory materials that create temporary surface modifications and temperature-responsive materials that create thermal sensations. Label 110 also uses mechanical feedback systems that provide resistance changes while coordinating with gamification features that provide positive reinforcement through pleasant tactile sensations.

At step 408, label 110 produces auditory responses that provide sound-based identification confirmation. Label 110 activates embedded sound chips programmed to emit specific sounds or melodies when triggered by user interaction, creating distinctive audio signatures that correspond to individual container identifications. In some cases, label 110 uses voice synthesis systems that provide spoken identification information and environmental sound detection that adjusts audio output levels. Label 110 also coordinates audio feedback with visual and tactile activation while maintaining antimicrobial surface treatments around sound generation components.

At step 410, label 110 evaluates whether all sensory channels have been properly activated and are functioning within specified parameters. Label 110 monitors activation status across visual, tactile, and auditory systems to ensure coordinated operation and detect any component failures or performance degradation. In some cases, label 110 runs diagnostic procedures that test individual channel functionality and collects user feedback that enables individuals to confirm adequate sensory confirmation. Label 110 also uses automated testing sequences that verify channel coordination and evaluation protocols that support gamification features by tracking successful activation events.

If not, all sensory channels are properly activated, method 400 returns to step 404 to enable additional activation attempts and system recalibration. Container labeling system 100 coordinates with labeling unit 102 to adjust activation parameters, modify timing sequences, and implement alternative activation methods that address identified performance limitations. In some cases, label 110 uses learning algorithms that analyze activation failure patterns and user guidance systems that provide optimization instructions. Label 110 also implements progressive activation strategies that gradually increase activation intensity to overcome environmental interference.

At step 412, label 110 completes multi-sensory identification. Label 110 records successful identification events within database 107 and provides confirmation feedback to users indicating proper container identification has been achieved. In some cases, label 110 activates gamification features that provide positive reinforcement and data collection procedures that record user interaction patterns. Label 110 also uses completion confirmation systems that provide clear success indication and post-completion monitoring that tracks container usage patterns while supporting antimicrobial surface treatments for ongoing illness prevention during social interactions.

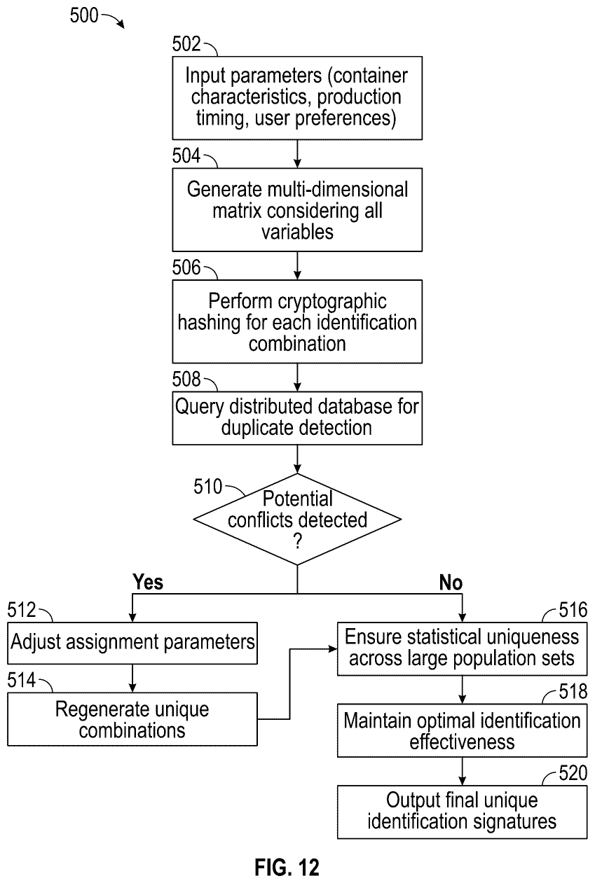

Now referring to FIG. 12, a method 500 for implementing a dynamic assignment algorithm that ensures unique identification signatures across container populations is explained, in accordance with one exemplary embodiment of the present invention. Method 500 may be described in the general context of computational processes and cryptographic verification systems. Generally, dynamic assignment processes may include parameter collection, matrix generation, cryptographic hashing, database querying, conflict detection, parameter adjustment, combination regeneration, statistical verification, effectiveness optimization, and signature output that create comprehensive uniqueness verification capabilities. Method 500 may also be practiced in distributed computing environments where assignment operations are coordinated across multiple processing systems and database repositories.

Method 500 begins at step 502. At step 502, container labeling system 100 receives input parameters including container characteristics, production timing, and user preferences to establish the foundation for unique identification signature generation. Container labeling system 100 receives input from labeling unit 102 that includes container geometry specifications, material properties, surface characteristics, and attachment method requirements. In some cases, container labeling system 100 coordinates with production scheduling systems to access timing information, batch specifications, and manufacturing constraints. Container labeling system 100 also collects user preferences, social environment specifications, and application context information for parties, schools, sporting events, and households.

At step 504, container labeling system 100 generates multi-dimensional matrices that consider all collected variables to create comprehensive parameter frameworks. Container labeling system 100 coordinates with control unit 104 to implement matrix generation algorithms that analyze parameter relationships, identify optimization opportunities, and establish computational frameworks that support unique identifier creation across large container populations. In some cases, container labeling system 100 uses machine learning algorithms to analyze historical assignment patterns and multi-dimensional analysis that evaluates parameter interactions. Container labeling system 100 also creates computational matrices that enable systematic uniqueness verification across production batches and user groups.

At step 506, container labeling system 100 performs cryptographic hashing for each identification combination to enable rapid duplicate detection. Container labeling system 100 applies cryptographic algorithms that transform identification parameter combinations into unique digital signatures that provide reliable verification capabilities while maintaining computational efficiency during high-volume production operations. In some cases, container labeling system 100 supports blockchain integration to provide immutable records and hierarchical verification systems that link individual containers to batch records. Container labeling system 100 also uses hash generation processes that accommodate various identification element types while maintaining consistent verification capabilities.

At step 508, container labeling system 100 queries distributed databases for duplicate detection to verify identification uniqueness across multiple data repositories. Container labeling system 100 coordinates with database 107 to access distributed identification records that span multiple production facilities, time periods, and container categories to ensure comprehensive uniqueness verification. In some cases, container labeling system 100 uses algorithms designed to generate unique label combinations and distributed database coordination that enables real-time verification across multiple manufacturing locations. Container labeling system 100 also implements querying processes that accommodate various container types through organized database structures.

At step 510, container labeling system 100 determines whether potential conflicts are detected during database verification operations. Container labeling system 100 implements decision algorithms that analyze database query results and assess conflict probability based on identification similarity, parameter overlap, and assignment timing factors. In some cases, container labeling system 100 evaluates identification assignments across specialized configurations for social environments and assesses identification assignments considering multiple element types and attachment method variations. Container labeling system 100 also implements evaluation algorithms that maintain uniqueness standards supporting comprehensive container identification through parameter-based identifier generation.

At step 512, container labeling system 100 adjusts assignment parameters to eliminate detected conflicts while maintaining identification effectiveness. Container labeling system 100 coordinates with control unit 104 to implement parameter adjustment algorithms that analyze conflict sources and apply targeted modifications to identification assignments without compromising overall system performance. In some cases, container labeling system 100 accommodates various attachment methods and container geometries while coordinating with existing identifiers including branding elements. Container labeling system 100 also implements modification algorithms that consider user preferences and social environment requirements when adjusting identification assignments.

At step 514, container labeling system 100 regenerates unique combinations that eliminate detected conflicts while maintaining distinctive recognition capabilities. Container labeling system 100 coordinates with cryptographic hashing processes from step 506 to generate new digital fingerprints for modified identification combinations and ensure conflict resolution maintains verification integrity. In some cases, container labeling system 100 incorporates machine learning algorithms to analyze successful assignment patterns and maintains specialized configuration requirements for social environments. Container labeling system 100 also implements generation algorithms that accommodate flexible integration capabilities by coordinating with existing manufacturing systems.

At step 516, container labeling system 100 ensures statistical uniqueness across large population sets through comprehensive verification processes. Container labeling system 100 coordinates with control unit 104 to implement statistical verification protocols that analyze identification effectiveness across different container types, user groups, and social environments while maintaining uniqueness standards. In some cases, container labeling system 100 incorporates blockchain integration capabilities to maintain immutable verification records and evaluates identification effectiveness across multiple element types. Container labeling system 100 also implements verification algorithms that coordinate with machine learning systems to optimize identification distribution patterns.

At step 518, container labeling system 100 maintains optimal identification effectiveness while ensuring assignment strategies provide reliable container recognition. Container labeling system 100 implements algorithms that analyze identification performance metrics, user interaction patterns, and recognition success rates to maintain optimal identification effectiveness while preserving uniqueness verification. In some cases, container labeling system 100 accommodates specialized configuration requirements for social environments and coordinates with various attachment methods and container geometries. Container labeling system 100 also implements effectiveness algorithms that support comprehensive container identification through parameter-based identifier generation.

At step 520, container labeling system 100 outputs final unique identification signatures for container assignment. Container labeling system 100 incorporates all verification processes, conflict resolution procedures, and optimization algorithms to create distinctive container identifications that meet uniqueness requirements and effectiveness standards. In some cases, container labeling system 100 coordinates with blockchain integration systems to create immutable records and provides identification signatures along with application specifications and user interaction guidelines. Container labeling system 100 also implements output generation algorithms that coordinate with various container types while providing comprehensive assignment specifications that complete the dynamic assignment process within container labeling system 100.

The presently disclosed invention may be implemented across diverse application scenarios where container identification provides functional benefits for users and organizations. In social gathering environments, the labels may enable party hosts to provide guests with uniquely labeled beverage containers that prevent accidental consumption and reduce waste from discarded unidentifiable drinks. The system may be deployed at wedding receptions, birthday parties, and holiday celebrations where multiple guests may have similar-looking beverages and require distinctive identification to maintain ownership clarity throughout extended social interactions.

Educational institutions may utilize the labels to implement hygiene protocols in cafeterias, classrooms, and recreational facilities where students and staff require reliable container identification to prevent inadvertent sharing of beverages and food containers. The labels may support school lunch programs by enabling students to identify their personal containers throughout the day while maintaining food safety standards and reducing waste from containers that cannot be identified after meal periods. In some cases, the labels may be integrated into educational activities where students learn about identification systems, manufacturing processes, and quality control procedures through hands-on interaction with labeled containers.

Corporate environments may implement the labels in office settings, conference rooms, and employee break areas where workers require distinctive container identification during meetings, training sessions, and collaborative work periods. The labels may support workplace wellness programs by enabling employees to track personal hydration goals through uniquely identified water bottles while maintaining hygiene standards in shared workspace environments. The labels may be deployed during corporate events, team-building activities, and professional conferences where attendees require reliable container identification throughout extended networking and presentation sessions.

Healthcare facilities may utilize the labels to implement infection control protocols in patient care areas, staff break rooms, and visitor spaces where container identification supports hygiene maintenance and prevents cross-contamination between individuals. The labels may enable healthcare workers to maintain personal beverage containers throughout extended shifts while ensuring compliance with facility cleanliness standards and patient safety requirements. In some cases, the labels may support patient care by enabling clear identification of personal items and reducing confusion in shared care environments where multiple individuals may have similar containers.

Recreational facilities including gyms, sports clubs, and fitness centers may implement the labels to enable members to identify personal water bottles and beverage containers throughout workout sessions and group activities. The labels may support athletic events and competitions where participants require reliable container identification during extended physical activities and team interactions. The labels may be deployed at swimming pools, tennis courts, and group fitness classes where members need to distinguish personal containers from those of other participants in shared recreational spaces.

Food service establishments including restaurants, cafes, and catering operations may utilize the labels to implement takeout and delivery identification systems that enable customers to identify their orders while supporting inventory tracking and quality control processes. The labels may enable food service workers to maintain accurate order fulfillment and reduce errors in customer service while supporting food safety protocols through reliable container identification. In some cases, the labels may support special dietary requirements by enabling clear identification of containers with specific ingredients or preparation methods that require careful handling and customer communication.

Manufacturing and industrial applications may implement the labels for inventory management, quality control, and supply chain tracking across production facilities where container identification supports operational efficiency and regulatory compliance. The labels may enable manufacturers to track container batches, production dates, and quality specifications throughout manufacturing processes while maintaining accurate inventory records and supporting automated sorting operations. The labels may be deployed in warehouse and distribution facilities where container identification supports logistics operations and enables accurate order fulfillment across diverse product categories and customer requirements.

The present invention provides significant advantages over prior art solutions through comprehensive identification capabilities that address limitations in existing container labeling technologies. Unlike prior art systems that rely primarily on color-coding or simple text-based identification, the present invention may incorporate multiple identification modalities including visual elements, tactile features, and technologically enhanced components that provide redundant recognition pathways for improved reliability across diverse user capabilities and environmental conditions. The labels may accommodate users with different visual abilities, literacy levels, and cultural backgrounds through pictographic elements and multi-sensory identification features that do not require text reading or color discrimination for effective container recognition.

The dynamic assignment algorithm of the present invention may provide superior uniqueness verification compared to prior art systems that utilize static identification schemes or limited identifier variations. The system may generate identification combinations through computational processes that analyze container characteristics, user preferences, and environmental factors to create distinctive signatures that maintain statistical uniqueness across large container populations. The cryptographic verification capabilities may prevent identifier duplication and support authenticity verification through immutable digital records that enable supply chain tracking and anti-counterfeiting measures beyond the capabilities of conventional labeling systems.

The flexible integration capabilities of the present invention may provide advantages over prior art solutions that require specialized containers or complex application procedures for effective implementation. The system may accommodate various container types, materials, and geometries through adaptable attachment methods that enable both manufacturing-stage and post-sale application scenarios. The system may coordinate with existing manufacturing processes, inventory management systems, and user interaction interfaces without requiring significant infrastructure modifications or specialized equipment investments that may limit adoption of alternative identification technologies.

The multi-sensory identification features of the present invention may provide enhanced recognition reliability compared to prior art systems that rely on single identification modalities that may be compromised by environmental conditions or user limitations. The system may activate visual, tactile, and auditory elements in coordinated sequences that provide comprehensive identification verification through multiple sensory channels simultaneously. The labels may adapt to different environmental conditions including low-light situations, noisy environments, and crowded social settings where single-modality identification systems may experience reduced effectiveness or user accessibility challenges. The comprehensive quality control and performance tracking capabilities of the present invention may provide operational advantages over prior art solutions that lack systematic verification and optimization features.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

### REFERENCE NUMERALS

100 container labeling system
102 labeling unit
104 control unit
106 applicator
107 database
108 container
109 cap
110 label
111 substrate
112 visual element
116 tactile element
118 QR code
120 barcode
124 security features
126 reflective surfaces
128 identifier section
130 branding section
132 information section
134 three-section layout
200 method for manufacturing labels
202 step for designing label with distinctive elements for container identification in social environments
204 step for selecting appropriate materials for printing or embedding distinctive elements
206 step for printing and rendering distinctive elements onto label substrates
208 step for applying adhesive layers to create bonding capabilities between label substrates and container surfaces
210 step for implementing die cutting operations that create final label shapes and dimensions
212 step for employing quality control procedures to verify label specifications and performance
214 step for updating packaging operations that prepare finished labels for distribution and application
300 method for determining label attachment methods
302 step for determining optimal label attachment methods based on container characteristics, application timing, and user requirements
304 step for evaluating whether label attachment will occur during manufacturing stages or through post-sale application by end users
306 step for implementing automated quality control systems that monitor attachment processes during manufacturing
308 step for integrating batch tracking systems that monitor container identification assignments
310 step for establishing manufacturing workflows that integrate attachment methods with existing production processes
312 step for preparing label application kits that enable end users to apply identification labels after purchase
314 step for developing user instruction protocols that provide clear guidance for label application
316 step for implementing digital verification systems that enable users to confirm proper label application
318 step for optimizing attachment methods for specific environmental conditions and user requirements
320 step for integrating digital features and completing final attachment to containers
400 method for multi-sensory identification
402 step for detecting user interaction triggers to activate multi-sensory identification
404 step for activating visual elements that provide immediate visual feedback and identification information
406 step for generating tactile feedback that provides physical confirmation of container identification
408 step for producing auditory responses that provide sound-based identification confirmation
410 step for evaluating whether all sensory channels have been properly activated and are functioning within specified parameters
412 step for completing multi-sensory identification and recording successful identification events
500 method for implementing dynamic assignment algorithm
502 step for receiving input parameters including container characteristics, production timing, and user preferences
504 step for generating multi-dimensional matrices that consider all collected variables to create comprehensive parameter frameworks
506 step for performing cryptographic hashing for each identification combination to enable rapid duplicate detection
508 step for querying distributed databases for duplicate detection to verify identification uniqueness
510 step for determining whether potential conflicts are detected during database verification operations
512 step for adjusting assignment parameters to eliminate detected conflicts while maintaining identification effectiveness
514 step for regenerating unique combinations that eliminate detected conflicts while maintaining distinctive recognition capabilities
516 step for ensuring statistical uniqueness across large population sets through comprehensive verification processes
518 step for maintaining optimal identification effectiveness while ensuring assignment strategies provide reliable container recognition
520 step for outputting final unique identification signatures for container assignment

What is claimed is:

1. A label for identifying a drink or other container, comprising:
a substrate configured for application to the container;
one or more distinctive elements integrated into the substrate for enabling visual or tactile distinction between otherwise similar-looking containers; and
wherein the label is configured for application pre-sale during manufacturing or post-sale by end users.

2. The label of claim 1, wherein the distinctive elements comprise visual identifiers selected from colors, patterns, letters, numbers, symbols, pictures, and logos, tactile elements selected from textures, raised surfaces, embossed areas, and engraved areas, or technologically enhanced features selected from machine-readable codes, security features, interactive digital elements, and specialty materials comprising luminescent, thermochromic, or reflective surfaces.

3. The label of claim 1, wherein the label is configured for integration into or affixation onto a bottle, cap, or closure of the container, and wherein the label is configured for use with beverage containers, consumable goods containers, or non-consumable containers.

4. The label of claim 1, wherein the label is configured as adhesive-backed, wrapped, printed, or otherwise affixed, and wherein the label is configured for one-time use or removable reusable scenarios while maintaining brand visibility and being shaped or sized to accommodate various container geometries including cylindrical, square, and curved containers.

5. The label of claim 1, wherein the label comprises a three-section layout including an identifier section containing distinctive pictographic elements, a central branding section, and an information section.

6. The label of claim 5, wherein the identifier section contains visual elements selected from emojis, animal images, symbols, and graphical icons that enable immediate visual recognition without requiring text reading.

7. The label of claim 1, wherein the label is specifically configured for identifying containers in social gatherings to prevent accidental consumption between multiple users in group environments.

8. The label of claim 7, wherein the distinctive elements comprise combinations of pictographic identifiers and textual information arranged to enable rapid identification in crowded social settings with varied lighting conditions.

9. A method for manufacturing labels for identifying containers, comprising:
providing a plurality of containers;
applying distinctive elements to label substrates to enable visual or tactile distinction between otherwise similar-looking containers;
configuring the labels for application pre-sale during manufacturing or post-sale by end users; and
ensuring each container in a batch has a unique identifier through dynamic assignment of distinct attributes.

10. The method of claim 9, wherein the applying step comprises designing distinctive identifiers and printing or otherwise rendering the identifiers on label stock using printing, embossing, debossing, or engraving techniques.

11. The method of claim 9, further comprising applying adhesives to the labels, die cutting the labels to their final shape, and performing quality control checks to ensure accurate representation of the distinctive elements.

12. The method of claim 9, wherein the distinctive elements are selected or generated based on parameters including container type, content, event, and time using databases or algorithms to generate unique label combinations.

13. The method of claim 9, wherein the labels are configured for identifying containers in social or group environments including parties, schools, sporting events, and households to prevent accidental consumption, spread of illness, and waste from discarded unidentifiable beverages.

14. The method of claim 9, wherein the method comprises a comprehensive process including designing distinctive identifiers, printing using various techniques, applying adhesives and quality control, linking to digital systems, generating unique combinations based on parameters, and configuring for social environment applications.

15. A system for labeling containers, comprising:
a labeling unit configured to apply distinctive elements to containers to enable visual or tactile distinction between otherwise similar-looking containers;
a control unit configured to dynamically assign and apply labels with distinct attributes; and
wherein the system ensures each container in a batch has a unique identifier and is configured for pre-sale or post-sale application.

16. The system of claim 15, wherein the labeling unit and control unit select or generate identifiers based on parameters including container type, content, event, and time, and wherein the system includes databases or algorithms to generate unique label combinations.

17. The system of claim 15, wherein the distinctive elements comprise any combination of visual identifiers, tactile elements, and technologically enhanced features, and wherein the system is configured for use with beverage containers, consumable goods containers, or non-consumable containers.

18. The system of claim 15, wherein the system is configured to incorporate existing identifiers including branding elements or be separate and auxiliary, and wherein the labels are configured as adhesive-backed, wrapped, printed, or otherwise affixed for various container geometries.

19. The system of claim 15, wherein the system is configured for identifying containers in social or group environments including parties, schools, sporting events, and households to prevent accidental consumption, spread of illness, and waste from discarded unidentifiable beverages.

20. The system of claim 15, wherein the system provides comprehensive container identification through parameter-based identifier generation, multiple element types, flexible integration capabilities, various attachment methods, and specialized configuration for social environments to prevent consumption errors and waste.
